(19) United States
(12) Patent Application Publication
(10) Pub. No.: US 2026/0024918 A1
(43) Pub. Date: Jan. 22, 2026

(54) ANTENNA STRUCTURE AND ELECTRONIC DEVICE

(71) Applicant: HUAWEI TECHNOLOGIES CO., LTD., Shenzhen, Guangdong (CN)

(72) Inventors: Ben LAI, Wuhan (CN); Bo HE, Wuhan (CN); Siting LI, Wuhan (CN); Jun YOU, Wuhan (CN); Yuzhen ZHANG, Wuhan (CN); Yunpeng SHEN, Wuhan (CN)

(21) Appl. No.: 18/995,508

(22) PCT Filed: Jan. 4, 2024
(86) PCT No.: PCT/CN2024/070638

§ 371 Date: Jan. 16, 2025

(30) Foreign Application Priority Data
Jan. 20, 2023 (CN) 202310104601.6

(51) Int. Cl. H01Q 9/04; H01Q 1/22; H01Q 1/48

(52) U.S. Cl. CPC H01Q 9/0421; H01Q 1/2266; H01Q 1/48

(57) ABSTRACT

Embodiments of this application provide an antenna structure and an electronic device. The antenna structure may include a ground plane, a first radiator, and a first grounding member connected to the first radiator. The antenna structure may further include a second radiator, a third radiator, a second grounding member connected to the second radiator, and a third grounding member connected to the third radiator. A first slot is formed between a first end of the first radiator and a first end of the second radiator, and a second slot is formed between a second end of the second radiator and a second end of the third radiator.

### CROSS-REFERENCE TO RELATED APPLICATIONS

This application is a National Stage of International Patent Application No. PCT/CN2024/070638, filed on Jan. 4, 2024, which claims priority to Chinese Patent Application No. 202310104601.6, filed on Jan. 20, 2023, both of which are hereby incorporated by reference in their entireties.

### TECHNICAL FIELD

This application relates to the field of wireless communication, and in particular, to an antenna structure and an electronic device.

### BACKGROUND

In a current state, communication frequency bands of an electronic device may be, for a long time, in a situation in which frequency bands of a third-generation mobile communication technology (3rd generation wireless systems (3G)), a fourth-generation mobile communication technology (4th generation wireless systems (4G)), and a fifth-generation mobile communication technology (5th generation wireless systems (5G)) coexist, and frequency band coverage is increasingly wide.

In addition, for a large-sized electronic device like a notebook computer, due to an architecture reason, an antenna is far away from a chip. As a result, a loss of an electrical signal in a transmission process is large. Therefore, efficiency of the antenna needs to be further improved, so that the electronic device has good communication performance. Based on these changes, it is urgent that the antenna on the electronic device has both a wide band and an efficient radiation characteristic.

### SUMMARY

Embodiments of this application provide an antenna structure and an electronic device. Corresponding resonances are generated in a plurality of different operating modes of the antenna structure. Based on a plurality of resonant frequency bands, the antenna structure can have a good operating bandwidth, and the antenna structure has good total efficiency in an operating frequency band.

According to a first aspect, an antenna structure is provided, including: a first radiator, a second radiator, and a third radiator, where a first slot is formed between a first end of the first radiator and a first end of the second radiator, a second slot is formed between a second end of the second radiator and a first end of the third radiator, a second end of the third radiator is an open end, the first radiator includes a first grounding point, the second radiator includes a second grounding point, the third radiator includes a third grounding point, and there is a gap between a ground plane and each of the first radiator, the second radiator, and the third radiator; and a first grounding member, a second grounding member, and a third grounding member, where a first end of the first grounding member is coupled to the first radiator at the first grounding point, a second end of the first grounding member is coupled to the ground plane, a first end of the second grounding member is coupled to the second radiator at the second grounding point, a second end of the second grounding member is coupled to the ground plane, a first end of the third grounding member is coupled to the third radiator at the third grounding point, and a second end of the third grounding member is coupled to the ground plane, where the first radiator or the first grounding member includes a feed point, the second radiator is coupled to the first radiator through the first slot, and the third radiator is coupled to the second radiator through the second slot.

According to embodiments of this application, the antenna structure includes a main radiation stub (including the feed point) formed by the first radiator and the first grounding member, a T-shaped stub formed by the second radiator and the second grounding member, and a T-shaped stub formed by the third radiator and the third grounding member, so that the antenna structure can have a plurality of resonant modes. Resonances generated in the resonant modes can be used to expand an operating bandwidth of the antenna structure, and the antenna structure has good total efficiency in resonant frequency bands of the resonances.

In one embodiment, a distance d1 from the first end of the first radiator to the first grounding point, a distance d2 from the first end of the second radiator to the second grounding point, a distance d3 from the second end of the second radiator to the second grounding point, a distance d4 from the first end of the third radiator to the third grounding point, and a distance d5 from the second end of the third radiator to the third grounding point satisfy d1×90%≤d2, d3, d4, and/or d5≤d1×110%.

According to embodiments of this application, d1, d2, d3, d4, and d5 may be approximately the same, and being approximately the same may be understood as that an error is within a range of 10%.

In one embodiment, a sum L1 of the distance from the first end of the first radiator to the first grounding point and a length of the first grounding member, a sum L2 of the distance from the first end of the second radiator to the second grounding point and a length of the second grounding member, a sum L3 of the distance from the second end of the second radiator to the second grounding point and the length of the second grounding member, a sum L4 of the distance from the second end of the third radiator to the third grounding point and a length of the third grounding member, and a sum L5 of the distance from the first end of the third radiator to the third grounding point and the length of the third grounding member are all less than or equal to

$$\frac{3}{10} λ ,$$

where λ is a wavelength corresponding to a first frequency band.

In one embodiment, L1, L2, L3, L4, and L5 are all greater than or equal to

$$\frac{1}{10} λ .$$

According to embodiments of this application, L1, L2, L3, L4, and L5 may be approximately the same, and being approximately the same may be understood as that an error is within a range of 10%.

In one embodiment,

$$\frac{1}{10} λ$$

### ≤L1, L2, L3, L4, and L5.

In one embodiment, a part from the first grounding point to the first end in the first radiator, the second radiator, and the third radiator are configured to jointly generate a first resonance, a second resonance, and a third resonance, a frequency of the first resonance is lower than a frequency of the second resonance, and the frequency of the second resonance is lower than a frequency of the third resonance.

According to embodiments of this application, the second resonance may correspond to a zero wavelength resonance of the antenna structure. The third resonance may correspond to a quarter wavelength resonance of the antenna structure. The first resonance may correspond to a negative half wavelength resonance of the antenna structure.

In one embodiment, at a first resonant frequency covered by the first resonance, currents on the first radiator and the second radiator on two sides of the first slot are in a same direction, currents on the second radiator on two sides of the second grounding point are in reverse directions, currents on the second radiator and the third radiator on two sides of the second slot are in a same direction, and currents on the third radiator on two sides of the third grounding point are in reverse directions; at a second resonant frequency covered by the second resonance, the currents on the first radiator and the second radiator on the two sides of the first slot are in a same direction, the currents on the second radiator on the two sides of the second grounding point are in a same direction, the currents on the second radiator and the third radiator on the two sides of the second slot are in a same direction, and the currents on the third radiator on the two sides of the third grounding point are in reverse directions; and at a third resonant frequency covered by the third resonance, the currents on the first radiator and the second radiator on the two sides of the first slot are in a same direction, the currents on the second radiator on the two sides of the second grounding point are in a same direction, the currents on the second radiator and the third radiator on the two sides of the second slot are in a same direction, and the currents on the third radiator on the two sides of the third grounding point are in a same direction.

In one embodiment, the antenna structure further includes a feed unit, the first grounding member includes the feed point, and the feed unit is coupled to the first grounding member at the feed point.

In one embodiment, the antenna structure further includes a feed unit, the first radiator includes the feed point, and the feed unit is coupled to the first radiator at the feed point.

According to embodiments of this application, the feed point may be disposed on the grounding member, or may be disposed on the radiator. This is not limited in embodiments of this application.

In one embodiment, the antenna structure further includes a fourth radiator and a fourth grounding member; and the first radiator further has a second end, and the first grounding point is disposed between the first end of the first radiator and a second end of the first radiator, where a third slot is formed between a first end of the fourth radiator and the second end of the first radiator; a second end of the fourth radiator is an open end; and the fourth radiator includes a fourth grounding point, a first end of the fourth grounding member is coupled to the fourth radiator at the fourth grounding point, and a second end of the fourth grounding member is coupled to the ground plane.

According to embodiments of this application, the fourth radiator and the fourth grounding member may be configured to generate a fourth resonance, to expand the operating frequency band of the antenna structure.

In one embodiment, the antenna structure further includes a fifth radiator and a fifth grounding member, and a fourth slot is formed between a first end of the fifth radiator and the second end of the third radiator; a second end of the fifth radiator is an open end; and the fifth radiator includes a fifth grounding point, a first end of the fifth grounding member is connected to the fifth radiator at the fifth grounding point, and a second end of the fifth grounding member is grounded.

According to embodiments of this application, a T-shaped stub is added on a side of the third radiator, so that the antenna structure generates a new resonance, and the operating bandwidth of the antenna structure is expanded by using a resonant frequency band of the newly generated resonance.

In one embodiment, the first radiator further has the second end, the first grounding point is disposed between the first end of the first radiator and the second end of the first radiator, and a distance from the second end of the first radiator to the first grounding point is different from the distance from the first end of the first radiator to the first grounding point.

According to embodiments of this application, a part between the second end of the first radiator and the first grounding point may be used to generate a fifth resonance, to expand the operating frequency band of the antenna structure.

In one embodiment, the first grounding member includes a first part and a second part that are connected, the first part is coupled to the first radiator at the first grounding point, and the second part is coupled to the ground plane; and a first plane on which the first part is located is different from a second plane on which the second part is located.

In one embodiment, a width of the first slot is less than or equal to 1 mm, and/or a width of the second slot is less than or equal to 1 mm.

According to embodiments of this application, a distance from an end part of the first end of the first radiator to an end part of the first end of the second radiator is less than or equal to 1 mm, or it may be understood as that a minimum value of the width of the first slot is less than or equal to 1 mm; and/or a distance from an end part of the second end of the second radiator to an end part of the first end of the third radiator is less than or equal to 1 mm, or it may be understood as that a minimum value of the width of the second slot is less than or equal to 1 mm. The first slot and the second slot may be equivalent to capacitors. The distance from the first end of the first radiator to the first end of the second radiator and the distance from the second end of the second radiator to the second end of the third radiator are set, so that energy of different intensity can be coupled to the second radiator and the third radiator, and a frequency of the resonance generated in the foregoing resonant mode deviates.

In one embodiment, a projection of the first radiator on the ground plane and a projection of the second radiator on the ground plane partially overlap.

According to embodiments of this application, the first radiator, the second radiator, and/or the third radiator may not be located in a same plane. In an actual design or application, a plurality of radiators (for example, three or more radiators) may be disposed based on a layout status in an electronic device.

In one embodiment, a projection of the first radiator on the ground plane and a projection of the second radiator on the ground plane do not overlap.

According to embodiments of this application, the first radiator, the second radiator, and the third radiator may be located in a same plane.

In one embodiment, the first slot and/or the second slot are/is in a fold-line shape.

According to a second aspect, an electronic device is provided, including the antenna structure according to any one of the implementations of the first aspect.

In one embodiment, the electronic device further includes a support plate; a first radiator and a third radiator are disposed on a first surface of the support plate, and a second radiator is disposed on a second surface of the support plate; and a projection of the first radiator on the second surface and the second radiator partially overlap, and a projection of the third radiator on the second surface and the second radiator partially overlap.

In one embodiment, the support plate includes a part of a printed circuit board, or the support plate includes an insulation support.

In one embodiment, the electronic device further includes an insulation housing; and the first radiator, the second radiator, and the third radiator are disposed on the housing.

In one embodiment, the electronic device further includes a conductive side frame, where the conductive side frame has a first position, a second position, a third position, and a fourth position, and the side frame is provided with a slit at each of the second position, the third position, and the fourth position; a side frame between the first position and the second position is a first side frame, a side frame between the second position and the third position is a second side frame, and a side frame between the third position and the fourth position is a third side frame; and the first radiator includes the first side frame, the second radiator includes the second side frame, and the third radiator includes the third side frame.

### BRIEF DESCRIPTION OF DRAWINGS

FIG. 1 is a diagram of an electronic device 10 according to an embodiment of this application;

FIG. 2 is a diagram of another electronic device 10 according to an embodiment of this application;

FIG. 3 is a diagram of an antenna structure 200 according to an embodiment of this application;

FIG. 4 is a diagram of an antenna structure 200 according to an embodiment of this application;

FIG. 5 is a diagram of a simulation result of an S parameter and total efficiency of the antenna structure 200 shown in FIG. 3;

FIG. 6 is a phase change curve of an electrical signal transmitted from a feed point to an end of a radiator in the antenna structure 200 shown in FIG. 3;

FIG. 7 is a diagram of current distribution of the antenna structure 200 shown in FIG. 3 at 4.2 GHz;

FIG. 8 is a diagram of current distribution of the antenna structure 200 shown in FIG. 3 at 5.2 GHz;

FIG. 9 is a diagram of current distribution of the antenna structure 200 shown in FIG. 3 at 6.5 GHz;

FIG. 10 is a diagram of another antenna structure 200 according to an embodiment of this application;

FIG. 11 is a diagram of a simulation result of an S parameter and total efficiency of the antenna structure 200 shown in FIG. 10;

FIG. 12 is a diagram of another antenna structure 200 according to an embodiment of this application;

FIG. 13 is a diagram of a simulation result of an S parameter and total efficiency of the antenna structure 200 shown in FIG. 12;

FIG. 14 is a diagram of another antenna structure 200 according to an embodiment of this application;

FIG. 15 is a diagram of a simulation result of an S parameter and total efficiency of the antenna structure 200 shown in FIG. 14;

FIG. 16 is a diagram of another antenna structure 200 according to an embodiment of this application;

FIG. 17 is a diagram of a simulation result of an S parameter and total efficiency of the antenna structure 200 shown in FIG. 16;

FIG. 18 is a diagram of another antenna structure 200 according to an embodiment of this application;

FIG. 19 is a diagram of a simulation result of an S parameter and total efficiency of the antenna structure 200 shown in FIG. 18;

FIG. 20 is a diagram of another antenna structure 200 according to an embodiment of this application; and

FIG. 21 is a diagram of a simulation result of an S parameter and total efficiency of the antenna structure 200 shown in FIG. 20.

### DESCRIPTION OF EMBODIMENTS

The following describes terms that may occur in embodiments of this application.

Coupling: The coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction of components. The direct coupling may also be understood as a form in which different components in a line structure are connected through physical lines that can transmit an electrical signal, such as a printed circuit board (PCB) copper foil or a conducting wire. The “indirect coupling” may be understood as that two conductors are electrically conducted in a spaced/non-contact manner. In an embodiment, the indirect coupling may also be referred to as capacitive coupling. For example, signal transmission is implemented by forming equivalent capacitor through coupling of a gap between two conductive components.

Radiator: The radiator is an apparatus used to receive/transmit electromagnetic wave radiation in an antenna. In some cases, an “antenna” is a radiator in a narrow sense. The radiator converts guided wave energy from a transmitter into a radio wave, or converts a radio wave into guided wave energy, to radiate and receive a radio wave. A modulated high-frequency current energy (or guided wave energy) generated by the transmitter is transmitted to a transmit radiator through a feeder. The radiator converts the energy into specific polarized electromagnetic wave energy and transmits the energy in a required direction. A receive radiator converts specific polarized electromagnetic wave energy from a specific direction in space into modulated high-frequency current energy, and transmits the energy to an input end of a receiver through a feeder.

The radiator may include a conductor having a specific shape and size, for example, a linear conductor or a sheet conductor. A specific shape is not limited in this application. In an embodiment, a linear radiator may be referred to as a linear antenna for short. In an embodiment, the linear radiator may be implemented by using a conductive side frame, and may also be referred to as a frame antenna. In an embodiment, the linear radiator may be implemented by using a support conductor, and may also be referred to as a support antenna. In an embodiment, a diameter (for example, including a thickness and a width) of a radiator of the linear radiator or the linear antenna is much less than (for example, less than 1/16 of) a wavelength (for example, a medium wavelength), and a length of the radiator may be compared to the wavelength (for example, the length is about ⅛ of the wavelength, or ⅛ to ¼ of the wavelength, or ¼ to ½ of the wavelength, or longer). Main forms of the linear antenna include a dipole antenna, a half-wave dipole antenna, a monopole antenna, a loop antenna, an inverted F antenna (IFA), and a planar inverted F antenna (PIFA). For example, for the dipole antenna, each dipole antenna usually includes two radiation stubs, and each stub is fed by a feed part from a feed end of the radiation stub. For example, the inverted F antenna (IFA) may be considered as being obtained by adding a grounding path to a monopole antenna. The IFA antenna has a feed point and a grounding point. A side view of the IFA antenna is of an inverted F shape. Therefore, the IFA antenna is referred to as an inverted F antenna. In an embodiment, a sheet radiator may include a microstrip antenna or a patch (patch) antenna. In an embodiment, the sheet radiator may be implemented by using a planar conductor (for example, a conductive sheet or a conductive coating). In an embodiment, the sheet radiator may include a conductive sheet, for example, a copper sheet. In an embodiment, the sheet radiator may include a conductive coating, for example, silver paste. A shape of the sheet radiator includes a circle, a rectangle, a ring, and the like. A specific shape is not limited in this application. A structure of the microstrip antenna generally includes a dielectric substrate, a radiator, and a ground plane, where the dielectric substrate is disposed between the radiator and the ground plane.

The radiator may further include a slit or a slot formed on a conductor, for example, a closed or semi-closed slit or slot formed on a grounded conductor surface. In an embodiment, a radiator having a slot or slit may be referred to as a slit antenna or a slot antenna for short. In an embodiment, a radiator having a closed slit or slot may be referred to as a closed slit antenna for short. In an embodiment, a radiator having a semi-closed slit or slot (for example, an opening is added to a closed slit or slot) may be referred to as an open slit antenna for short. In some embodiments, a shape of the slot is a long strip. In some embodiments, a length of the slot is about half a wavelength (for example, a medium wavelength). In some embodiments, the length of the slot is about an integer multiple of wavelengths (for example, one time the medium wavelength). In some embodiments, the slot may be fed through a transmission line that is cross-connected to one side or two sides of the slot. In this way, a radio frequency electromagnetic field is excited on the slot, and an electromagnetic wave is radiated to space. In an embodiment, the radiator of the slit antenna or the slot antenna may be implemented by a conductive side frame that is grounded at two ends, and may also be referred to as a frame antenna. In this embodiment, it may be considered that the slit antenna or the slot antenna includes a linear radiator, and the linear radiator and a ground plane are spaced from each other and two ends of the radiator are grounded, to form a closed or semi-closed slit or slot. In an embodiment, the radiator of the slit antenna or the slot antenna may be implemented by using a support conductor that is grounded at two ends, and may also be referred to as a support antenna.

Lumped element/component: A lumped element/component is a collective name for components whose sizes are far less than a wavelength corresponding to a circuit operating frequency. For a signal, component characteristics are always fixed at any time, regardless of a frequency.

Distributed element/component: Different from the lumped element, if an element has a size close to or greater than a wavelength of a circuit operating frequency, characteristics of the element vary according to a signal when the signal passes through the element. In this case, the element cannot be considered as a single entity with fixed characteristics, but should be referred to as a distributed element.

Capacitor: The capacitor may be understood as a lumped capacitor and/or a distributed capacitor. The lumped capacitor is a capacitive component, for example, a capacitive element. The distributed capacitor is an equivalent capacitor formed by a gap between two conductors.

Inductor: The inductor may be understood as a lumped inductor and/or a distributed inductor. The lumped inductor refers to a component that is inductive, for example, a capacitive element. The distributed inductor refers to an equivalent inductor formed by using a conductive part of a specific length, for example, an equivalent inductor formed by a conductor through curling or rotation.

Resonance/Resonant frequency: The resonant frequency is also referred to as a resonance frequency. The resonant frequency may have a frequency range, namely, a frequency range in which a resonance occurs. The resonant frequency may be a frequency range in which a return loss characteristic is less than −6 dB. The frequency corresponding to a strongest resonance point is a center frequency. A return loss of the center frequency may be less than −20 dB. It should be understood that, unless otherwise specified, in “generating a first resonance” by an antenna/radiator mentioned in this application, the first resonance is a fundamental mode resonance generated by the antenna/radiator, or a resonance with a lowest frequency that is generated by the antenna/radiator in a specific antenna mode.

Resonant frequency band: A range of a resonant frequency is the resonant frequency band, and a return loss characteristic of any frequency in the resonant frequency band may be less than −6 dB or −5 dB.

Communication frequency band/Operating frequency band: Regardless of a type of an antenna, the antenna always operates within a specific frequency range (a frequency band width). For example, an operating frequency band of an antenna supporting a B40 frequency band includes a frequency ranging from 2300 MHz to 2400 MHz. In other words, an operating frequency band of the antenna includes the B40 frequency band. A frequency range that meets a requirement of an indicator may be considered as the operating frequency band of the antenna.

The resonant frequency band and the operating frequency band may be the same or different, or frequency ranges of the resonant frequency band and the operating frequency band may partially overlap. In an embodiment, one or more resonant frequency bands of the antenna may cover one or more operating frequency bands of the antenna.

Electrical length: The electrical length may be a ratio of a physical length (namely, a mechanical length or a geometric length) to a wavelength of a transmitted electromagnetic wave. The electrical length may satisfy the following formula:

$$\overline{L} = \frac{L}{λ}$$

Herein, L is the physical length, and λ is the wavelength of the electromagnetic wave.

Wavelength: The wavelength, or an operating wavelength, may be a wavelength corresponding to a center frequency of a resonant frequency or a center frequency of an operating frequency band supported by an antenna. For example, it is assumed that a center frequency of a B1 uplink frequency band (with a resonant frequency ranging from 1920 MHz to 1980 MHz) is 1955 MHz, the operating wavelength may be a wavelength calculated by using the frequency of 1955 MHz. The “operating wavelength” is not limited to the center frequency, and may alternatively be a wavelength corresponding to a resonant frequency or a frequency of an operating frequency band other than a center frequency.

It should be understood that, the wavelength (the operating wavelength) may be understood as a wavelength of an electromagnetic wave in a medium. For example, a wavelength of an electromagnetic wave generated by a radiator transmitted in a medium and a wavelength transmitted in a vacuum satisfy the following formula:

$${λ}_{ε} = \frac{{λ}_{c}}{\sqrt{{ε}_{r}}}$$

λ_{ε} is the wavelength of the electromagnetic wave in the medium, λ_{c} is the wavelength of the electromagnetic wave in the vacuum, and εᵣ is a relative dielectric constant of the medium in a medium layer. The wavelength in embodiments of this application is usually a medium wavelength, and may be a medium wavelength corresponding to the center frequency of the resonant frequency, or a medium wavelength corresponding to the center frequency of the operating frequency band supported by the antenna. For example, it is assumed that a center frequency of a B1 uplink frequency band (with a resonant frequency ranging from 1920 MHz to 1980 MHz) is 1955 MHz, the wavelength may be a medium wavelength calculated by using the frequency of 1955 MHz. The “medium wavelength” is not limited to the center frequency, and may alternatively be a medium wavelength corresponding to a resonant frequency or a frequency of an operating frequency band other than a center frequency. For ease of understanding, the medium wavelength mentioned in embodiments of this application may be simply calculated by using a relative dielectric constant of a medium filled on one or more sides of a radiator.

End/point: The “end/point” as in a first end/second end/feed end/grounding end/feed point/grounding point/connection point of a radiator of an antenna cannot be understood as a point in a narrow sense, and may alternatively be considered as a section of a radiator including a first endpoint on the radiator of the antenna. In addition, the end cannot be understood as an endpoint or an end part that is disconnected from another radiator in a narrow sense, and may alternatively be considered as a point or a section on a continuous radiator. In an embodiment, the “end/point” may include an end point of the radiator of the antenna at a first slot. For example, the first end of the radiator of the antenna may be considered as a section of the radiator that is within 5 mm (for example, 2 mm) away from the slot on the radiator. In an embodiment, the “end/point” may include a connection/coupling area that is on the radiator of the antenna and that is coupled to another conductive structure. For example, the feed end/feed point may be a coupling area (for example, an area that is face-to-face with a part of a feed circuit) that is on the radiator of the antenna and that is coupled to a feed structure or a feed circuit. For another example, the grounding end/grounding point may be a connection/coupling area that is on the radiator of the antenna and that is coupled to a grounding structure or a grounding circuit.

Open end and closed end: In some embodiments, whether it is the open end or the closed end depends on, for example, whether the open end/closed end is grounded. The closed end is grounded, and the open end is not grounded. In some embodiments, whether it is the open end or the closed end depends on, for example, another conductor. The closed end is electrically connected to the another conductor, and the open end is not electrically connected to the another conductor. In an embodiment, the open end may also be referred to as an opening end or an open-circuit end. In an embodiment, the closed end may also be referred to as a grounding end or a short-circuit end. It should be understood that, in some embodiments, another conductor may be coupled by using an open end, to transfer coupling energy (which may be understood as transferring a current).

Current distribution in a same direction/reverse directions mentioned in embodiments of this application should be understood as that main currents on conductors on a same side are in a same direction/reverse directions. For example, when currents distributed in a same direction are excited on a bent conductor or an annular conductor (for example, a current path is also bent or annular), it should be understood that although main currents excited on conductors on two sides of the annular conductor (for example, on conductors around a slot, or on conductors on two sides of a slot) are in reverse directions, the main currents still meet a definition of the currents distributed in a same direction in this application. In an embodiment, that currents on a conductor are in a same direction may mean that the currents on the conductor have no reverse point. In an embodiment, that currents on a conductor are in reverse directions may mean that the currents on the conductor have at least one reverse point. In an embodiment, that currents on two conductors are in a same direction may mean that none of the currents on the two conductors has a reverse point and the currents flow in the same direction. In an embodiment, that currents on two conductors are in reverse directions may mean that none of the currents on the two conductors has a reverse point and the currents flow in the reverse directions. That currents on a plurality of conductors are in a same direction/reverse directions may be understood accordingly.

A limitation on a position and a distance, like a middle or a middle position, mentioned in embodiments of this application represents a specific range. For example, a middle (position) of a conductor may be a section of a conductor part including a midpoint on the conductor, for example, the middle (position) of the conductor may be a section of the conductor part whose distance from the midpoint on the conductor is less than a predetermined threshold (for example, 1 mm, 2 mm, or 2.5 mm).

Total efficiency of an antenna: The total efficiency is a ratio of input power to output power at a port of the antenna.

Radiation efficiency of an antenna: The radiation efficiency is a ratio of power radiated by the antenna to space (that is, power for effectively converting an electromagnetic wave) to active power input to the antenna. The active power input to the antenna=input power of the antenna−loss power. The loss power mainly includes return loss power and metal ohmic loss power and/or medium loss power. The radiation efficiency is a value for measuring a radiation capability of the antenna. The metal loss and the medium loss are both factors that affect the radiation efficiency.

A person skilled in the art may understand that the efficiency is usually represented by using a percentage, and there is a corresponding conversion relationship between the efficiency and dB. Efficiency closer to 0 dB indicates better antenna efficiency.

Antenna return loss: The antenna return loss may be understood as a ratio of power of a signal reflected back to a port of an antenna through circuit of the antenna to transmit power of the port of the antenna. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of S-parameters. S11 indicates a reflection coefficient, and the parameter is used to measure transmit efficiency of the antenna. The S11 parameter is usually a negative number. A smaller value of the S11 parameter indicates a smaller return loss of the antenna and less energy reflected back by the antenna. In other words, more energy actually enters the antenna and total efficiency of the antenna is higher. A larger S11 parameter indicates a larger return loss of the antenna and lower total efficiency of the antenna.

It should be noted that, in engineering, a value −6 dB of S11 is generally used as a standard. When the value of S11 of the antenna is less than −6 dB, it may be considered that the antenna can operate normally, or it may be considered that the transmit efficiency of the antenna is good.

Ground/Ground plane: The ground/ground plane may generally represent at least a part of any grounding plane, or grounding plate, or grounding metal layer of an electronic device (for example, a mobile phone), or at least a part of any combination of the grounding plane, the grounding plate, the grounding component, or the like. The “ground/ground plane” may be used for grounding a component of the electronic device. In an embodiment, the “ground” may be a grounding plane of a circuit board of the electronic device, or may be a grounding plate formed by a middle frame of the electronic device or a grounding metal layer formed by a metal film below a display of the electronic device. In an embodiment, the circuit board may be a printed circuit board (PCB), for example, an 8-layer board, a 10-layer board, or a 12-layer board, a 13-layer board, or a 14-layer board respectively having 8, 10, 12, 13, or 14 layers of conductive materials, or a component that is separated and electrically insulated by a dielectric layer or an insulation layer, for example, glass fiber or polymer.

Any one of the foregoing grounding plane, the grounding plate, or the grounding metal layer is made of a conductive material. In an embodiment, the conductive material may be any one of the following materials: copper, aluminum, stainless steel, brass, and an alloy thereof, copper foil on an insulation substrate, aluminum foil on an insulation substrate, gold foil on an insulation substrate, silver-plated copper, silver-plated copper foil on an insulation substrate, silver foil on an insulation substrate and tin-plated copper, cloth impregnated with graphite powder, a graphite-coated substrate, a copper-plated substrate, a brass-plated substrate, and an aluminum-plated substrate. A person skilled in the art may understand that the grounding plane/grounding plate/grounding metal layer may alternatively be made of another conductive material.

Grounding: The grounding refers to coupling with the foregoing ground/ground plane in any manner. In an embodiment, the grounding may be physical grounding, for example, physical grounding (or referred to as a physical ground) at a specific position on a side frame is implemented by using some mechanical parts of a middle frame. In an embodiment, the grounding may be grounding by using a component, for example, grounding (or referred to as a component ground) by using a component like a capacitor/inductor/resistor connected in series or in parallel.

The following describes the technical solutions in embodiments of this application with reference to the accompanying drawings.

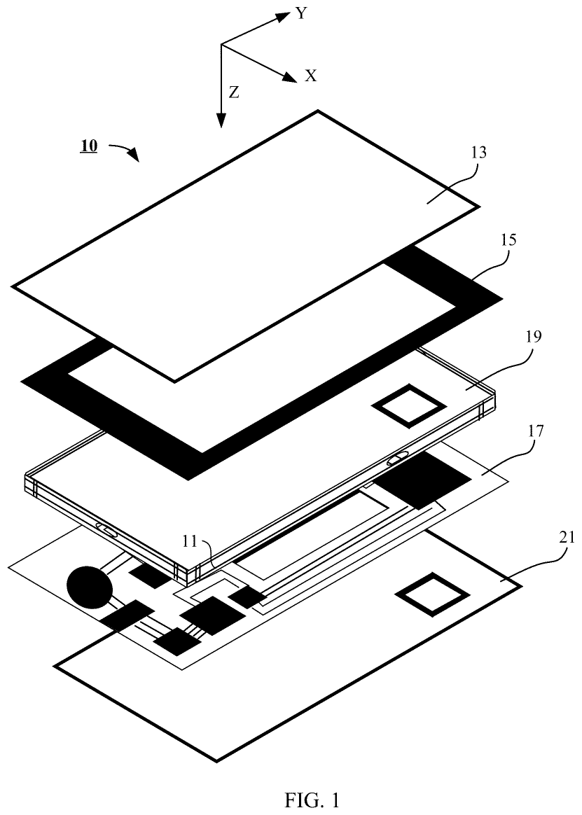

As shown in FIG. 1, an electronic device 10 may include a cover 13, a display/display module (display) 15, a printed circuit board (PCB) 17, a middle frame 19, and a rear cover 21. It should be understood that, in some embodiments, the cover 13 may be cover glass, or may be replaced with a cover of another material, for example, a cover of a PET (Polyethylene terephthalate, polyethylene terephthalate) material.

The cover 13 may be disposed close to the display module 15, and may be mainly configured to protect and prevent dust on the display module 15.

In an embodiment, the display module 15 may include a liquid crystal display (LCD), a light-emitting diode (LED) display panel, an organic light-emitting diode (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers dielectric board, or may be a dielectric board mixing Rogers and FR-4, or the like. The FR-4 is a grade code name of a flame-resistant material, and the Rogers dielectric plate is a high-frequency plate. An electronic element, for example, a radio frequency chip, is carried on the PCB 17. In an embodiment, a metal layer may be disposed on the printed circuit board PCB 17. The metal layer may be used for grounding an electronic element carried on the printed circuit board PCB 17, or may be used for grounding another component, for example, a support antenna or a frame antenna. The metal layer may be referred to as a ground plane, a grounding plane, or a grounding plane. In an embodiment, the metal layer may be formed by etching metal on a surface of any layer of dielectric plates in the PCB 17. In an embodiment, the metal layer used for grounding may be disposed on a side that is of the printed circuit board PCB 17 and that is close to the middle frame 19. In an embodiment, an edge of the printed circuit board PCB 17 may be considered as an edge of the grounding plane of the PCB 17. In an embodiment, the metal middle frame 19 may also be used for grounding the foregoing components. The electronic device 10 may further have another ground plane/grounding plate/grounding plane. As described above, details are not described herein again.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a main board and a sub-board. The battery may be disposed between the main board and the sub-board. The main board may be disposed between the middle frame 19 and an upper edge of the battery, and the sub-board may be disposed between the middle frame 19 and a lower edge of the battery.

The electronic device 10 may further include a side frame 11. The side frame 11 may be formed of a conductive material like metal. The side frame 11 may be disposed between the display module 15 and the rear cover 21, and extends circumferentially around a periphery of the electronic device 10. The side frame 11 may have four sides surrounding the display module 15 to help secure the display module 15. In an implementation, the side frame 11 made of a metal material may be directly used as a metal side frame of the electronic device 10 to form a metal side frame appearance, and is applicable to a metal industrial design (ID). In another implementation, an outer surface of the side frame 11 may alternatively be made of a non-metal material, for example, a plastic side frame, to form a non-metal side frame appearance, and is applicable to a non-metal ID.

The middle frame 19 may include the side frame 11, and the middle frame 19 including the side frame 11 serves as an integral part, and may support electronic elements in the entire electronic device. The cover 13 and the rear cover 21 are respectively snapped together along an upper edge and a lower edge of the side frame, to form a casing or a housing of the electronic device. In an embodiment, the cover 13, the rear cover 21, the side frame 11, and/or the middle frame 19 may be collectively referred to as the casing or the housing of the electronic device 10. It should be understood that, the “casing or housing” may indicate a part or all of any one of the cover 13, the rear cover 21, the side frame 11, or the middle frame 19, or indicate a part or all of any combination of the cover 13, the rear cover 21, the side frame 11, or the middle frame 19.

The side frame 11 on the middle frame 19 may be at least partially used as a radiator of an antenna to transmit/receive a radio frequency signal. There may be a gap between the side frame that serves as the radiator and another part of the middle frame 19, to ensure that the radiator of the antenna has a good radiation environment. In an embodiment, the side frame that serves as the radiator on the middle frame 19 may be provided with an aperture, to facilitate radiation of the antenna.

Alternatively, the side frame 11 may not be considered as a part of the middle frame 19. In an embodiment, the side frame 11 may be connected to the middle frame 19 and integrally formed with the middle frame 19. In another embodiment, the side frame 11 may include a protrusion extending inward, to be connected to the middle frame 19, for example, connected through a spring or a screw, or connected through welding. The protrusion of the side frame 11 may be further configured to receive a feed signal, so that at least a part of the side frame 11 serves as a radiator of an antenna to transmit/receive a radio frequency signal. There is a gap 42 between the part of side frame that serves as the radiator and the middle frame 30, to ensure that the antenna radiator has a good radiation environment, so that the antenna has a good signal transmission function.

The rear cover 21 may be a rear cover made of a metal material, or a rear cover made of a non-conductive material, for example, a glass rear cover, a plastic rear cover, and the like; or a rear cover made of both a conductive material and a non-conductive material. In an embodiment, the rear cover 21 including the conductive material may replace the middle frame 19, and serve as an integrated component with the side frame 11, to support electronic elements in the entire electronic device.

In an embodiment, the middle frame 19 and/or a conductive part of the rear cover 21 may be used as a reference ground of the electronic device 10. The side frame 11, the PCB 17, and the like of the electronic device may be grounded by being electrically connected to the middle frame.

Alternatively, the antenna of the electronic device 10 may be disposed in the side frame 11. When the side frame 11 of the electronic device 10 is of a non-conductive material, the radiator of the antenna may be located in the electronic device 10 and disposed along the side frame 11. For example, the radiator of the antenna is disposed adjacent to the side frame 11, so that a size occupied by the antenna radiator is reduced, and the radiator of the antenna is closer to the outside of the electronic device 10, to better transmit a signal. It should be noted that, that the antenna radiator is disposed adjacent to the side frame 11 means that the antenna radiator may be disposed in close contact with the side frame 11, or may be disposed close to the side frame 11. For example, there may be a small gap between the antenna radiator and the side frame 11.

Alternatively, the antenna of the electronic device 10 may be disposed in the housing, for example, a support antenna or a millimeter wave antenna (not shown in FIG. 1). Clearance of the antenna disposed in the housing may be obtained by a slot/hole in any one of the middle frame, and/or the side frame, and/or the rear cover, and/or the display, or by a non-conductive slot/aperture formed between any several of the middle frame, the side frame, the rear cover, and the display. According to the setting of a clearance of the antenna, radiation performance of the antenna is ensured. It should be understood that, the clearance of the antenna may be a non-conductive area formed by any conductive component in the electronic device 10, and the antenna radiates a signal to external space through the non-conductive area. In an embodiment, the antenna 40 may be an antenna form based on a flexible printed circuit (FPC), an antenna form based on laser-direct-structuring (LDS), or an antenna form like a microstrip disk antenna (MDA). In an embodiment, the antenna may alternatively be of a transparent structure embedded in the display of the electronic device 10, so that the antenna is a transparent antenna element embedded in the display of the electronic device 10.

FIG. 1 shows only an example of some components included in the electronic device 10. An actual shape, an actual size, and an actual configuration of the components are not limited to those in FIG. 1.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that, when a user holds (usually vertically and facing the display) the electronic device, a position in which the electronic device is located includes a top, a bottom, a left, and a right. It should be understood that, in embodiments of this application, it is considered that, when a user holds (usually vertically and facing the display) the electronic device, a position in which the electronic device is located includes a top, a bottom, a left, and a right.

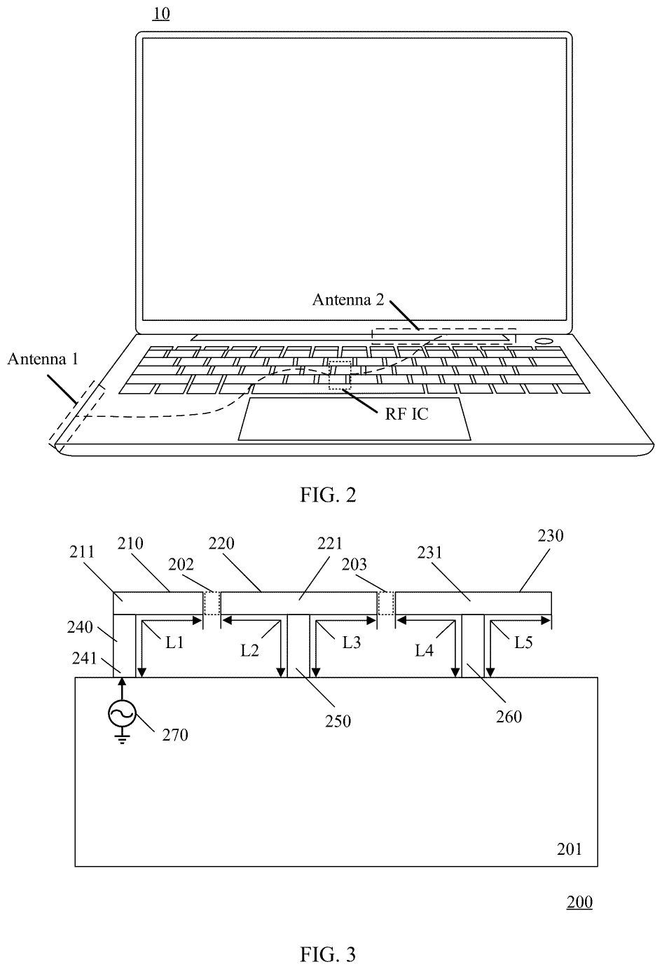

A radio frequency chip (RF IC) is usually disposed on a PCB of the electronic device, and a radiator of the antenna is disposed based on an actual layout of the electronic device. In some large-sized electronic devices, for example, a notebook computer, due to a layout of components, an RF IC is disposed at a keyboard, and an antenna is disposed at a rotating shaft and an edge of a housing, as shown in FIG. 2. Because the antenna is far away from the RF IC, a loss is large in a process of transmitting the electrical signal from the RF IC to the antenna. Consequently, radiation performance of the antenna deteriorates. Therefore, the efficiency of the antenna needs to be improved, so that the antenna has good radiation performance.

In addition, with an increase of communication frequency bands, for example, in a Wi-Fi 6E architecture, a 6 GHz frequency band (5.925 GHz to 7.125 GHZ) is added based on a 2.4 GHz frequency band (2.4 GHz to 2.483 GHZ) and a 5 GHz frequency band (5.15 GHz to 5.85 GHz). In this way, an operating bandwidth of the antenna is further expanded. Therefore, it is urgent that an antenna on an electronic device has both a wide band and an efficient radiation characteristic.

Embodiments of this application provide an antenna structure and an electronic device. The antenna structure generates corresponding resonances in a plurality of different operating modes. Based on a plurality of resonant frequency bands, the antenna structure can have a good operating bandwidth, and the antenna structure has good total efficiency in an operating frequency band.

FIG. 3 is a diagram of an antenna structure 200 according to an embodiment of this application.

As shown in the figure, the antenna structure 200 may include a ground plane 201, a first radiator 210, a second radiator 220, a third radiator 230, a first grounding member 240, a second grounding member 250, and a third grounding member 260.

There is a gap between the ground plane 201 and each of the first radiator 210, the second radiator 220, and the third radiator 230.

A first slot 202 may be formed between a first end of the first radiator 210 and a first end of the second radiator 220. In an embodiment, the first end of the first radiator 210 and the first end of the second radiator 220 are opposite and not in contact with each other.

In an embodiment, the first end of the first radiator 210 is an open end. In an embodiment, the first end of the second radiator 220 is also an open end.

A second slot 203 may be formed between a second end of the second radiator 220 and a first end of the third radiator 230. In an embodiment, the second end of the second radiator 220 and the first end of the third radiator 230 are opposite and not in contact with each other.

In an embodiment, a second end of the third radiator 230 is an open end. Specifically, the second end of the third radiator 230 is not grounded. In an embodiment, no electronic element is disposed (for example, electrically connected or indirectly coupled) between the second end of the third radiator 230 and the ground plane 201. In an embodiment, the second end of the second radiator 220 is also an open end.

In an embodiment, the first radiator 210, the second radiator 220, and the third radiator 230 may be located in a same plane. In an embodiment, the first slot 202 may be formed between the first end of the first radiator 210 and the first end of the second radiator 220 in a first direction. The second slot 203 may be formed between the second end of the second radiator 220 and the first end of the third radiator 230 in the first direction. The first direction may be an extension direction of a length of the first radiator 210.

The first radiator 210 includes a first grounding point 211, the second radiator 220 includes a second grounding point 221, and the third radiator 230 includes a third grounding point 231. A first end of the first grounding member 240 is coupled to the first radiator 210 at the first grounding point 211, and a second end of the first grounding member 240 is coupled to the ground plane 201, to be grounded through the ground plane 201. A first end of the second grounding member 250 is coupled to the second radiator 220 at the second grounding point 221, and a second end of the second grounding member 250 is coupled to the ground plane 201, to be grounded through the ground plane 201. A first end of the third grounding member 260 is coupled to the third radiator 230 at the third grounding point 231, and a second end of the third grounding member 360 is coupled to the ground plane 201, to be grounded through the ground plane 201.

It should be understood that, for brevity of description, the accompanying drawings in embodiments of this application merely use a direct electrical connection as an example for description. In practice, indirect coupling may alternatively be used for implementation. A structure of the indirect coupling is different from a structure of the electrical connection. A structure in this application may be replaced based on an actual requirement, to implement coupling in an indirect manner. This is not limited in this application.

In an embodiment, the first grounding member 240, the second grounding member 250, and the third grounding member 260 may be located in a same plane. In an embodiment, based on layout space in an electronic device, the first grounding member 240, the second grounding member 250, and the third grounding member 260 may be located in different planes.

An operating frequency band of the antenna structure 200 may include a first frequency band. In an embodiment, the first frequency band may include some frequency bands in Wi-Fi, for example, a 5 GHz frequency band (5.15 GHz to 5.85 GHZ) and a 6 GHz frequency band (5.925 GHz to 7.125 GHz).

A sum L1 of a distance from the first end of the first radiator 210 to the first grounding point 211 and a length of the first grounding member 240, a sum L2 of a distance from the first end of the second radiator 220 to the second grounding point 221 and a length of the second grounding member 250, a sum L3 of a distance from the second end of the second radiator 220 to the second grounding point 221 and the length of the second grounding member 250, a sum L4 of a distance from the first end of the third radiator 230 to the third grounding point 231 and a length of the third grounding member 260, and a sum L5 of a distance from the second end of the third radiator 230 to the third grounding point 231 and the length of the third grounding member 260 satisfy L1, L2, L3, L4, and L5≤3λ/10, where λ is a wavelength corresponding to the first frequency band. The wavelength corresponding to the first frequency band may be understood as a vacuum wavelength corresponding to a center frequency of the first frequency band, or may be understood as a vacuum wavelength corresponding to a resonant point generated by the antenna structure in the first frequency band.

It should be understood that the sum of the distance from the first end of the first radiator 210 to the first grounding point 211 and the length of the first grounding member 240 may alternatively be understood as a distance from the first end of the first radiator 210 to the second end of the first grounding member 240.

In an embodiment, the first radiator 210 or the first grounding member 240 includes a feed point, and the feed point receives a corresponding radio frequency signal.

In an embodiment, the second radiator 220 is coupled to the first radiator 210 through the first slot. The second radiator 220 couples energy through the first radiator 210, to radiate a radio frequency signal.

In an embodiment, the third radiator 230 is coupled to the second radiator 220 through the second slot. The third radiator 230 couples energy through the second radiator 220, to radiate a radio frequency signal.

It should be understood that, in the technical solutions provided in embodiments of this application, the antenna structure includes an active radiation stub (including the feed point) formed by the first radiator and the first grounding member, a passive radiation stub (including no feed point) formed by the second radiator 220 and the second grounding member 250, and a passive radiation stub formed by the third radiator 230 and the third grounding member 260. In an embodiment, all of the passive radiation stubs are T-shaped stubs. In embodiments of this application, the antenna structure provides a plurality of resonant modes by using a plurality of radiators. Resonances generated in the resonant modes can be used to expand an operating bandwidth of the antenna structure. In addition, the antenna structure has good total efficiency in resonant frequency bands of the resonances.

The antenna structure in embodiments of this application has the plurality of radiators, and therefore, may be considered as an antenna structure having a metamaterial (Metamaterial, also referred to as meta) feature (a meta antenna structure or a meta antenna for short). In an embodiment, the plurality of radiators are sequentially arranged in an end-to-end manner, and this may be considered as forming a structure of a metaline antenna. The structure is a form of a meta antenna, and may be understood as a meta antenna structure formed by arraying the plurality of radiators in one direction. It should be understood that the antenna structure in embodiments of this application is considered as having a meta antenna feature, to facilitate understanding of embodiments of this application, instead of limiting this application.

In an embodiment, L1, L2, L3, L4, and L5 satisfy L1, L2, L3, L4, and L5≥λ/10.

In an embodiment, L1, L2, L3, L4, and L5 satisfy L1×90%≤L2, L3, L4, and/or L5≤L1×110%.

It should be understood that L1, L2, L3, L4, and L5 may be approximately the same, and being approximately the same may be understood as that an error is within a range of 10%.

In an embodiment, the distance d1 from the first end of the first radiator 210 to the first grounding point 211, the distance d2 from the first end of the second radiator 220 to the second grounding point 221, the distance d3 from the second end of the second radiator 220 to the second grounding point 221, the distance d4 from the first end of the third radiator 230 to the third grounding point 231, and the distance d5 from the second end of the third radiator 230 to the third grounding point 231 satisfy d1×90%≤d2, d3, d4, and/or d5≤d1×110%.

It should be understood that d1, d2, d3, d4, and d5 may be approximately the same, and being approximately the same may be understood as that an error is within a range of 10%.

In an embodiment, the first grounding point 211 is located at a second end of the first radiator 210, and the first radiator 210 and the first grounding member 240 form an L-shaped structure.

In an embodiment, the antenna structure 200 further includes a feed unit 270. The first grounding member 240 includes a feed point 241. The feed unit 240 is coupled to the first grounding member 240 at the feed point 241, and feeds an electrical signal into the antenna structure 240.

In an embodiment, the first radiator 210, the second radiator 220, and the third radiator 230 may be configured to jointly generate a first resonance and a second resonance, and a frequency of the first resonance is lower than a frequency of the second resonance. In an embodiment, a resonant frequency band of the first resonance and a resonant frequency band of the second resonance may include the first frequency band. It should be understood that in embodiments of this application, “jointly generating a resonance” may be understood as that a change of an electrical length of any radiator affects the resonance. In an embodiment, when one radiator is removed, a resonance in a same operating frequency band or adjacent operating frequency bands cannot be generated, for example, an original resonance deviates from a center frequency of the original resonance by more than 30%.

In an embodiment, the first resonance may correspond to a zero wavelength resonance of the antenna structure 200. In an embodiment, the second resonance may correspond to a quarter wavelength resonance of the antenna structure 200. It should be understood that, the foregoing resonant mode may be understood as a phase change value of an electrical signal fed from the feed point and transmitted from the feed point to an end of the radiator (the second end of the third radiator 230). A 180° phase may correspond to a half wavelength. Therefore, when a phase of the electrical signal transmitted from the feed point to the end of the radiator does not change or changes by approximately 0°, it is equivalent to that an electrical length through which the electrical signal passes in the process is zero, and the electrical length may correspond to the foregoing zero wavelength resonance. When the phase of the electrical signal transmitted from the feed point to the end of the radiator lags for approximately 90 degrees, it is equivalent to that the electrical length through which the electrical signal passes in the process is a quarter wavelength, and the electrical length may correspond to the foregoing quarter wavelength resonance.

In an embodiment, the first radiator 210, the second radiator 220, and the third radiator 230 may be further configured to jointly generate a third resonance, where a frequency of the third resonance is lower than the frequency of the first resonance, and the third resonance may be used to expand a communication frequency band of the antenna structure 200.

In an embodiment, the third resonance may correspond to a negative half wavelength resonance of the antenna structure 200. It should be understood that the foregoing negative half wavelength resonance may be understood as that when a phase of an electrical signal transmitted from the feed point to the end of the radiator is ahead for approximately 180°, it is equivalent to that an electrical length through which the electrical signal passes in the process is a negative half wavelength.

In an embodiment, a distance from the first end of the first radiator 210 to the first end of the second radiator 220 is less than or equal to 1 mm. Alternatively, it may be understood as that a width of the first slot 202 is less than or equal to 1 mm. It should be understood that the distance from the first end of the first radiator 210 to the first end of the second radiator 220 may be understood as a minimum distance from an end part of the first end of the first radiator 210 to an end part of the first end of the second radiator 220. An end-to-end distance in the following embodiment may also be correspondingly understood. The width of the first slot 202 may be understood as a minimum value of the width of the first slot 202, and the width of the slot in the following embodiments may also be correspondingly understood.

In addition/Alternatively, a distance from the second end of the second radiator 220 to the first end of the third radiator 230 is less than or equal to 1 mm. Alternatively, it may be understood as that a width of the second slot 203 is less than or equal to 1 mm.

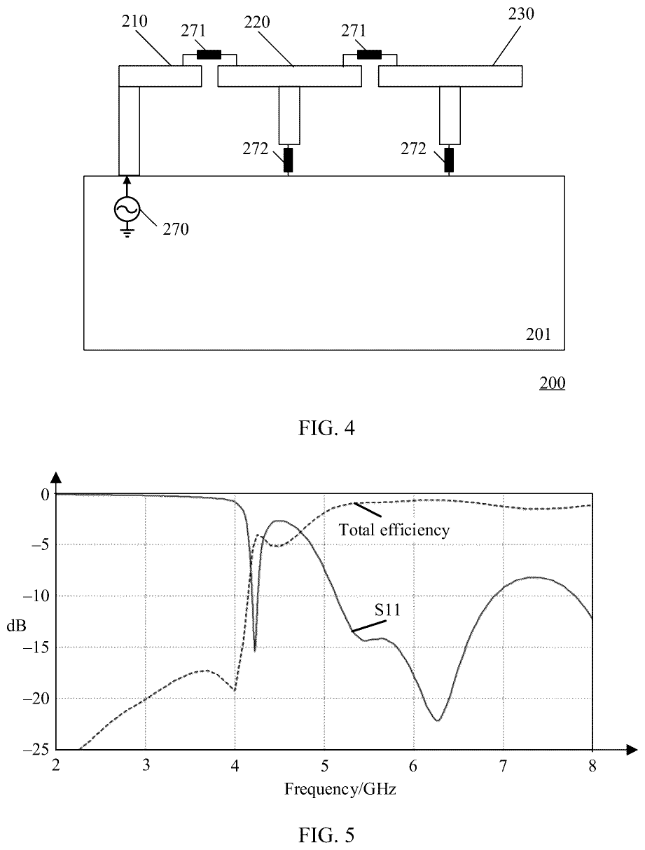

It should be understood that the first slot and the second slot may be equivalent to capacitors. The distance from the first end of the first radiator 210 to the first end of the second radiator 220 and the distance from the second end of the second radiator 220 to the first end of the third radiator 230 are set, so that energy of different intensity can be coupled to the second radiator 220 and the third radiator 230, and a frequency of the resonance generated in the foregoing resonant mode deviates. In an embodiment, an electronic element 271 may be electrically connected between end parts of adjacent radiators, as shown in FIG. 4, so that a capacitance value of a capacitor equivalent to a slot changes.

In an embodiment, the electronic element 271 may be electrically connected between radiators on two sides of a slot. For example, the electronic element 271 is electrically connected between the first end of the first radiator 210 and the first end of the second radiator 220 on two sides of the first slot. In an embodiment, a distance from the first slot to an electrical connection point between the electronic element 271 and the first radiator 210 or the second radiator 220 may be less than a first threshold. In an embodiment, the first threshold may be a value less than 5 mm. For example, the first threshold is 2 mm or 1 mm. It should be understood that, in embodiments of this application, electronic elements electrically connected between radiators on two sides of a slot may be disposed with reference to the foregoing descriptions.

In an embodiment, the electronic element 271 may include a capacitor.

In an embodiment, a length of the first grounding member 240, the second grounding member 250, or the third grounding member 260 is less than 2 mm. It should be understood that, the first grounding member 240, the second grounding member 250, or the third grounding member 260 may be equivalent to inductors. Different lengths of the first grounding member 240, the second grounding member 250, or the third grounding member 260 are set, so that a frequency of a resonance generated in the foregoing resonant mode deviates. In an embodiment, an electronic element 272 may be electrically connected between the grounding member and the ground plane 201, as shown in FIG. 4, so that an inductance value of an inductor equivalent to the grounding member changes.

In an embodiment, the electronic element 272 may be electrically connected to the grounding member at any position of the grounding member. For brevity of description, in this embodiment of this application, an example in which the electronic element 272 is electrically connected between an end part of a second end of the grounding member and the ground plane 201 is used for description only. This is not limited in this embodiment of this application.

In an embodiment, the electronic element 272 may include an inductor.

In an embodiment, the distance L1 from the first end of the first radiator 210 to the first grounding point 211, the distance from the first end of the second radiator 220 to the second grounding point 221, the distance from the second end of the second radiator 220 to the second grounding point 221, the distance from the first end of the third radiator 230 to the third grounding point 231, and the distance from the second end of the third radiator 230 to the third grounding point may be different, so that a frequency of a resonance generated in the foregoing resonant mode deviates.

FIG. 5 is a diagram of a simulation result of an S parameter and total efficiency of the antenna structure 200 shown in FIG. 3.

As shown in FIG. 5, the antenna structure may generate resonances near 4.2 GHz, 5.2 GHz, and 6.5 GHZ, and the resonances correspond to the third resonance, the first resonance, and the second resonance. When S11<−6 dB, the operating frequency band of the antenna structure may include 5.15 GHz to 5.85 GHz and 5.925 GHz to 7.125 GHz, which may correspond to a 5 GHz frequency band (5.15 GHz to 5.85 GHZ) of Wi-Fi and a newly added 6 GHz frequency band (5.925 GHz to 7.125 GHz) of Wi-Fi 6E.

In addition, total efficiency of the antenna structure in the operating frequency band is greater than −3 dB. That is, the antenna structure has good total efficiency.

For brevity of description, in the foregoing embodiments, an example in which the resonant frequency bands of the first resonance and the second resonance include the 5 GHz frequency band and the 6 GHz frequency band of Wi-Fi is used for description. In practice, an electrical parameter of the radiator or the grounding member of the antenna structure may be controlled, so that the resonant frequency bands of the first resonance and the third resonance include the 5 GHz frequency band and the 6 GHz frequency band of Wi-Fi. This is not limited in embodiments of this application, and may be determined based on actual production or design.

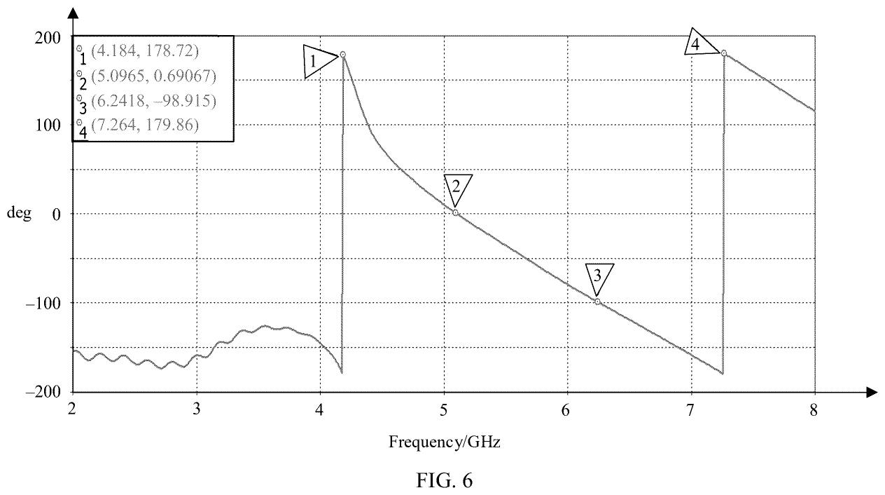

FIG. 6 is a phase change curve of the electrical signal transmitted from the feed point to the end of the radiator (the second end of the third radiator 230) in the antenna structure 200 shown in FIG. 3.

As shown in FIG. 6, at a first resonant frequency covered by the first resonance, or at a first resonant frequency (where 5.09 GHz is used as an example) covered by the first resonance, the phase of the electrical signal transmitted from the feed point to the end of the radiator changes by approximately 0° (0°±45°), and it is equivalent to that an electrical length through which the electrical signal passes in the process is zero, and may correspond to the foregoing zero wavelength resonance.

At a second resonant frequency covered by the second resonance, or at a second resonant frequency (where 6.24 GHz is used as an example) covered by the second resonance, the phase of the electrical signal transmitted from the feed point to the end of the radiator lags for approximately 90° (−90°±45°), and it is equivalent to that the electrical length through which the electrical signal passes in the process is a quarter, and may correspond to the foregoing quarter wavelength resonance.

At a third resonant frequency covered by the third resonance, or at a third resonant frequency (where 4.18 GHz is used as an example) covered by the third resonance, the phase of the electrical signal transmitted from the feed point to the end of the radiator is ahead for approximately 180° (180°±45°), and it is equivalent to that the electrical length through which the electrical signal passes in the process is a negative half, and may correspond to the foregoing negative half wavelength resonance.

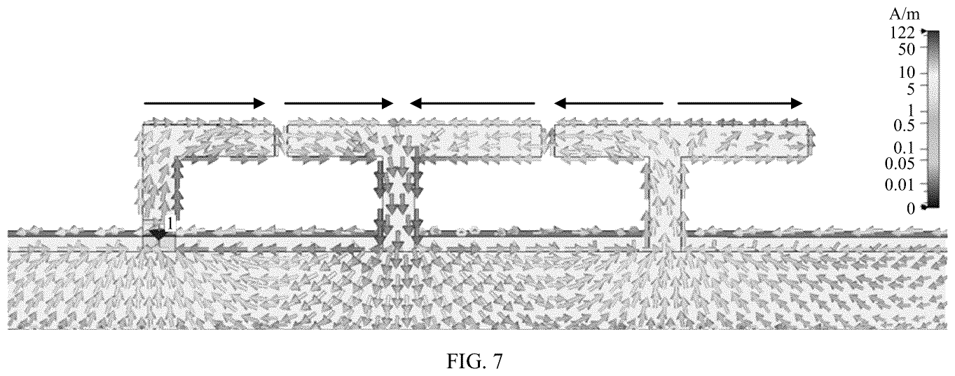

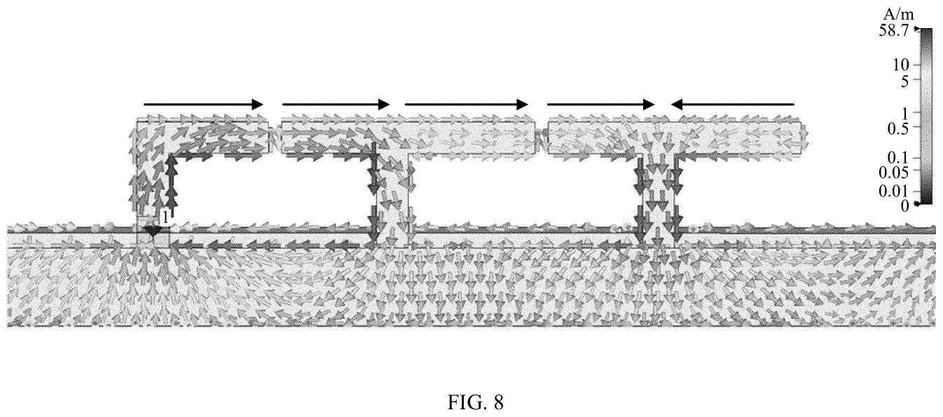

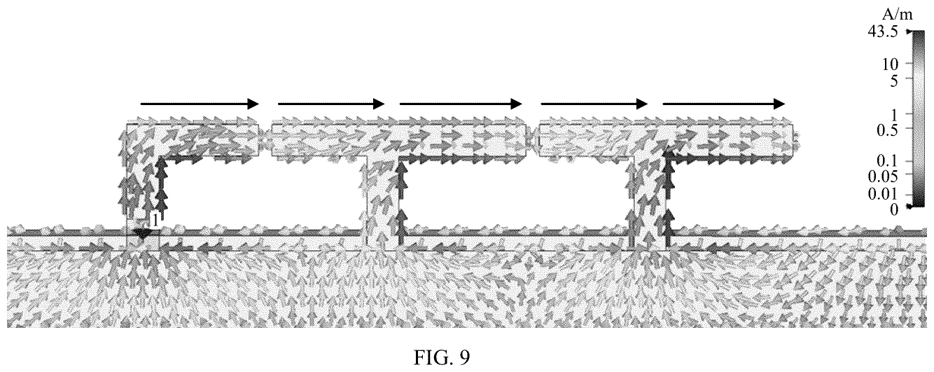

FIG. 7 to FIG. 9 are diagrams of current distribution of the antenna structure 200 shown in FIG. 3. FIG. 7 is a diagram of current distribution of the antenna structure 200 shown in FIG. 3 at a resonant frequency (for example, 4.2 GHz) in the third frequency band. FIG. 8 is a diagram of current distribution of the antenna structure 200 shown in FIG. 3 at a resonant frequency (for example, 5.2 GHz) in the first frequency band. FIG. 9 is a diagram of current distribution of the antenna structure 200 shown in FIG. 3 at a resonant frequency (for example, 6.5 GHZ) in the second frequency band.

As shown in FIG. 7 to FIG. 9, a current on each branch (on a radiator from a grounding point to an end part) is in a quarter wavelength mode, current intensity from the grounding point to the end part is unidirectionally distributed in descending order, and there is no current reverse point. In current distribution of each frequency band, a grounding point area of a radiator is a strong current area, and a slot between adjacent radiators is a weak current area.

It should be understood that radiators between adjacent grounding points (for example, a partial first radiator and a partial second radiator between the first grounding point and the second grounding point) may form a structure similar to a slot antenna. Therefore, the structure can be analyzed based on a current mode of the slot antenna.

A radiator (for example, the second radiator on the two sides of the second grounding point) on two sides of a grounding point may form a structure similar to a linear antenna (for example, a T antenna). Therefore, the structure can be analyzed based on a current mode of the linear antenna.

At the slot formed between adjacent radiators (for example, the first slot formed between the first end of the first radiator and the first end of the second radiator), currents in a same direction on two sides of the slot may be defined as C-mode currents of the slot antenna, and currents in reverse directions on two sides of the slot may be defined as D-mode currents of the slot antenna. At the grounding point of the radiator, currents in a same direction on two sides of the grounding point may be defined as D-mode currents of the linear antenna, and currents in reverse directions on two sides of the grounding point may be defined as C-mode currents of the linear antenna.

As shown in FIG. 7, a current mode from the grounding point of the first radiator to the second end of the third radiator is C-C-C-C (where on the two sides of the first slot, currents on the first radiator and the second radiator are in a same direction; on the two sides of the second grounding point, currents on the second radiator are in reverse directions; on two sides of the second slot, currents on the second radiator and the third radiator are in a same direction; and on two sides of the third grounding point, currents on the third radiator are in reverse directions).

As shown in FIG. 8, the current mode from the grounding point of the first radiator to the second end of the third radiator is C-D-C-C (where on the two sides of the first slot, the currents on the first radiator and the second radiator are in a same direction; on the two sides of the second grounding point, the currents on the second radiator are in a same direction; on the two sides of the second slot, the currents on the second radiator and the third radiator are in a same direction; and on the two sides of the third grounding point, the currents on the third radiator are in reverse directions).

As shown in FIG. 9, the current mode from the grounding point of the first radiator to the second end of the third radiator is C-D-C-D (where on the two sides of the first slot, the currents on the first radiator and the second radiator are in a same direction; on the two sides of the second grounding point, the currents on the second radiator are in a same direction; on two sides of the second slot, the currents on the second radiator and the third radiator are in a same direction; and on the two sides of the third grounding point, the currents on the third radiator are in a same direction).

As an operating frequency generated by an antenna structure moves from a low frequency to a high frequency, a proportion of D-mode currents in current distribution gradually increases.

In an embodiment, the first radiator, the second radiator, and the third radiator may be considered as of a meta antenna structure, and a radiator diameter of the antenna structure may be increased, to increase a radiation diameter of the antenna structure. For example, the current distribution shown in FIG. 9 is used as an example. From the grounding point of the first radiator to the second end of the third radiator, all currents on the radiators are in a same direction, and there is no current reverse point, so that an operating mode of the antenna structure is a quarter wavelength mode. However, an electrical length from the grounding point of the first radiator to the second end of the third radiator is far greater than a quarter wavelength, which is equivalent to increasing a radiation diameter of the antenna structure, and improving efficiency of the antenna structure.

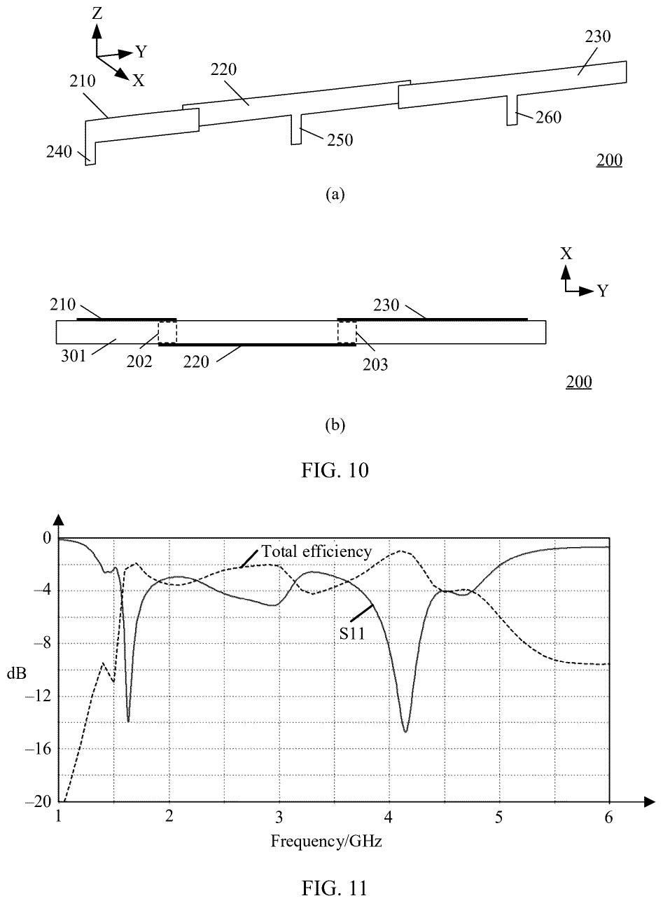

FIG. 10 is a diagram of another antenna structure 200 according to an embodiment of this application.

As shown in (a) in FIG. 10, the first end of the first radiator 210 and the first end of the second radiator 220 are disposed opposite to each other, and the second end of the second radiator 220 and the first end of the third radiator 230 are disposed opposite to each other.

It should be understood that, in an embodiment of the antenna structure 200 shown in FIG. 3, any two adjacent radiators of the first radiator 210, the second radiator 220, and the third radiator 230 may be located in a same plane. In an embodiment, a projection of the first radiator 210 on the ground plane and a projection of the second radiator 220 on the ground plane do not overlap.

A similar position relationship may exist between the second radiator 220 and the third radiator 230. Details are not described herein again.

In another embodiment, any two adjacent radiators of the first radiator 210, the second radiator 220, and the third radiator 230 may be located in different planes. In an embodiment, a projection of the first radiator 210 on the ground plane and a projection of the second radiator 220 on the ground plane partially overlap.

A difference between the antenna structure 200 shown in FIG. 10 and the antenna structure 200 shown in FIG. 3 lies in that at least two adjacent radiators of the first radiator 210, the second radiator 220, and the third radiator 230 are not located in a same plane. In the antenna structure 200 shown in FIG. 10, the first radiator 210 and the third radiator 230 may be located in a same plane. In an embodiment, the first radiator 210 and the second radiator 220 may not be located in a same plane, and the projection of the first radiator 210 on the ground plane and the projection of the second radiator 220 on the ground plane partially overlap. In an embodiment, the second radiator 220 and the third radiator 230 may not be located in a same plane, and the projection of the second radiator 220 on the ground plane and the projection of the third radiator 230 on the ground plane partially overlap. In an embodiment, the first radiator 210, the second radiator 220, and the third radiator 230 may all be located in different planes. It should be understood that, for brevity of description, in this embodiment of this application, that the radiators are located in two different planes is merely used as an example for description. In an actual design or application, a plurality of radiators (for example, three or more radiators) may be disposed based on a layout status in the electronic device.

In an embodiment, the antenna structure 200 further includes a support plate 301. The support plate 301 is an insulated support plate. The first radiator 210 and the third radiator 230 are disposed on a first surface of the support plate 301, and the second radiator 220 is disposed on a second surface of the support plate 301. A projection of the first radiator 210 on the second surface and the second radiator 220 partially overlap, and a projection of the third radiator 230 on the second surface and the second radiator 220 partially overlap.

In an embodiment, the support plate 301 may include a part of a printed circuit board (PCB). In an embodiment, the support plate 301 may include an insulation support, and the insulation support may be generally referred to as an antenna support. In an embodiment, the substrate 301 may alternatively be at least one layer of dielectric plate in a plurality of stacked dielectric plates in the PCB.

In an embodiment, the first slot 202 may be formed between the first end of the first radiator 210 and the first end of the second radiator 220 in a second direction, as shown in (b) in FIG. 10. The second slot 203 may be formed between the second end of the second radiator 220 and the first end of the third radiator 230 in the second direction. The second direction may be a direction perpendicular to a plane on which the first radiator 210 is located.

It should be understood that, when a slot is formed between adjacent radiators in the second direction, a width of the slot may be understood as a distance between the adjacent radiators in the second direction, or may be understood as a size of the support plate 301 in the second direction.

In an embodiment, a size of an overlapping part of the first projection or the third projection and the second radiator 220 in the first direction may be less than or equal to 2 mm, and the first direction may be an extension direction of a length of the first radiator 210.

FIG. 11 is a diagram of a simulation result of an S parameter and total efficiency of the antenna structure 200 shown in FIG. 10.

As shown in FIG. 11, a radiator is disposed by using a support plate, and a slot is formed between adjacent radiators in the second direction, so that the antenna structure may generate a plurality of resonances, and an operating frequency band of the antenna structure is expanded by using resonant frequency bands of the plurality of resonances.

In addition, total efficiency of the antenna structure in the resonant frequency bands of the resonances is greater than −4 dB. That is, the antenna has good total efficiency.

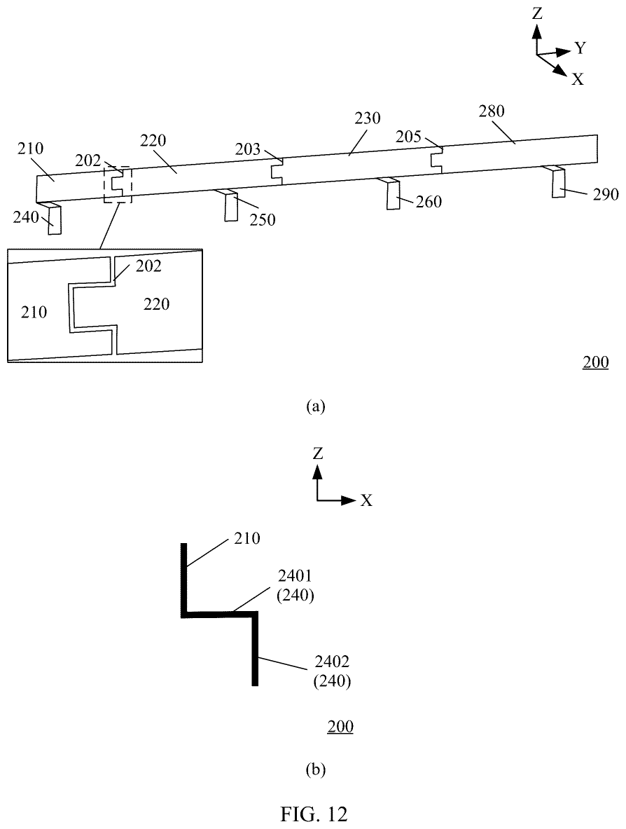

FIG. 12 is a diagram of another antenna structure 200 according to an embodiment of this application.

As shown in (a) in FIG. 12, the antenna structure 200 may further include a fourth radiator 280 and a fourth grounding member 290.

A fourth slot 205 is formed between a first end of the fourth radiator 280 and the second end of the third radiator 230, and a second end of the fourth radiator 280 is an open end. In an embodiment, the first end of the fourth radiator 280 and the second end of the third radiator 230 are opposite and not in contact with each other. The fourth radiator 280 includes a fourth grounding point, a first end of the fourth grounding member 290 is connected to the fourth radiator 280 at the fourth grounding point, and a second end of the fourth grounding member 290 is grounded through the ground plane 201.

It should be understood that a difference between the antenna structure 200 shown in FIG. 12 and the antenna structure 200 shown in FIG. 3 lies only in the fourth radiator 280 and the fourth grounding member 290. In the antenna structure 200 shown in FIG. 12, the fourth radiator 280 and the fourth grounding member 290 may be configured to increase a resonant mode of the antenna structure 200, so that the antenna structure 200 shown in FIG. 12 may generate an additional resonant mode based on the antenna structure 200 shown in FIG. 3, and resonances generated in the resonant mode can be used to expand the operating frequency band of the antenna structure 200.

In an embodiment, the first slot 202, the second slot 203, or the fourth slot 205 is in a fold-line shape. In an embodiment, the two radiators forming the slot 202/203/205 have corresponding two ends of an interdigital shape. In an embodiment, a recess part is disposed at the first end of the first radiator 210, a corresponding protrusion part is disposed at the first end of the second radiator 220, and the first slot 202 formed between the first end of the first radiator 210 and the first end of the second radiator 220 may be in a fold-line shape. It should be understood that, in this embodiment of this application, a slot formed between end parts of adjacent radiators may be disposed based on an actual internal layout of the electronic device. The slot may be in a straight-line shape, a fold-line shape, or a curve shape, and widths of all parts of the slot may be different. This is not limited in this embodiment of this application.

It should be understood that, when the slot is in the fold-line shape, a requirement in the foregoing embodiment is still met. For example, a width of the slot (a minimum width of the slot) is less than or equal to 1 mm.

In an embodiment, as shown in (b) in FIG. 12, the first end of the first grounding member 240 is bent in a third direction (where the third direction is a direction from the first grounding member 240 to the first radiator 210, for example, an x direction). The first grounding member 240 is divided into a first part 2401 and a second part 2402 at a bent part. The first part 2401 is connected to the first radiator 210, and the second part 2402 is grounded. In an embodiment, a first plane on which the first part 2401 is located is different from a second plane on which the second part 2402 is located. It should be understood that the grounding member in embodiments of this application may be in a fold-line shape. Because another component further needs to be disposed in the electronic device, the grounding member in the fold-line shape can be flexibly adapted to different space reserved for the antenna structure in the electronic device.

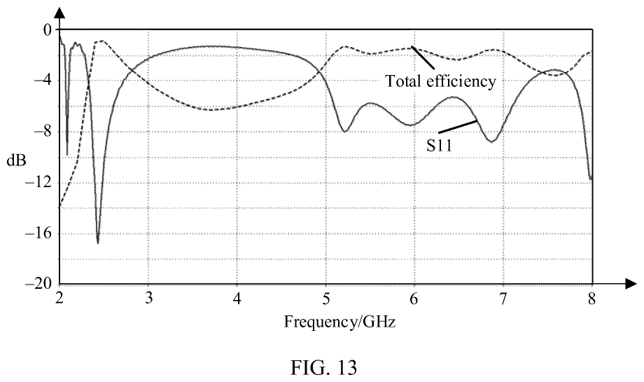

FIG. 13 is a diagram of a simulation result of an S parameter and total efficiency of the antenna structure 200 shown in FIG. 12.

As shown in FIG. 13, compared with the antenna structure 200 shown in FIG. 3, the antenna structure 200 shown in FIG. 12 adds a T-shaped stub formed by the fourth radiator 280 and the fourth grounding member 290. Therefore, the operating bandwidth of the antenna structure 200 is increased. When S11<−4 dB, the operating frequency band of the antenna structure may include a 2.4 GHz frequency band, the 5 GHz frequency band, and the 6 GHz frequency band of Wi-Fi.

In addition, total efficiency of the antenna structure in the operating frequency band is greater than −4 dB. That is, the antenna structure has good total efficiency.

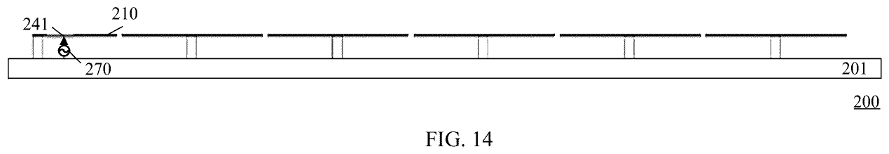

FIG. 14 is a diagram of another antenna structure 200 according to an embodiment of this application.

It should be understood that, based on the antenna structure 200 shown in FIG. 3, a T-shaped stub formed by the fourth radiator 280 and the fourth grounding member 290 is added to the antenna structure 200 shown in FIG. 12, to expand the resonant mode of the antenna structure, thereby increasing the operating bandwidth of the antenna structure. When a clearance (namely, a distance from the radiator to the ground plane 201) of the antenna structure 200 is small, for example, less than 1 mm, a resonant frequency band of a single resonance is narrow. Based on the antenna structure 200 shown in FIG. 12, a T-shaped stub formed by at least one radiator and a grounding member may be added to a side of the T-shaped stub formed by the fourth radiator and the fourth grounding member, as shown in FIG. 14. In the antenna structure 200 shown in FIG. 14, by using the added T-shaped stub, the plurality of T-shaped stubs may be arranged periodically, so that the antenna structure generates a new resonance, and the operating bandwidth of the antenna structure is expanded by using a resonant frequency band of the newly generated resonance.

It should be understood that the antenna structure 200 shown in FIG. 14 is merely used as an example. In practice, the antenna structure 200 may include N T-shaped stubs formed by N radiators and N grounding members that are disposed on a same side of the first radiator 210, where N is an integer greater than or equal to 2, and a quantity of N may be determined based on actual production or setting. Ends of the N radiators are open ends, where the end may be understood as an end that is of a radiator that is in the N radiators and that is farthest away from the first radiator 210 and that is not adjacent to another radiator. In an embodiment, a width of a slot formed between two adjacent radiators (namely, a distance between end parts of the adjacent radiators) meets a requirement in the foregoing embodiment, for example, is less than or equal to 1 mm.

In an embodiment, the feed point 241 is located on the first radiator 210. The feed unit 270 is coupled to the first radiator 210 at the feed point 241, and feeds an electrical signal for the antenna structure 200.

In an embodiment, the foregoing radiators may be all disposed on an insulation housing of the electronic device, for example, disposed on an upper surface or a lower surface of the insulation housing, or embedded in the insulation housing. The insulation housing may be an insulation rear cover or an insulation front cover.

It should be understood that, in the foregoing embodiment, a position of the radiator is merely used as an example. In practice, the radiator may be further disposed on an inner side of an insulation side frame of the electronic device, to be disposed in a position inside the electronic device and close to external space. In an embodiment, the radiator may alternatively be implemented by using a side frame of the electronic device. In an embodiment, the electronic device further includes a conductive side frame, and the side frame has a first position, a second position, a third position, and a fourth position. The side frame is provided with a slit at each of the second position, the third position, and the fourth position. A side frame between the first position and the second position is a first side frame, a side frame between the second position and the third position is a second side frame, and a side frame between the third position and the fourth position is a third side frame. The first radiator includes the first side frame, the second radiator includes the second side frame, and the third radiator includes the third side frame.

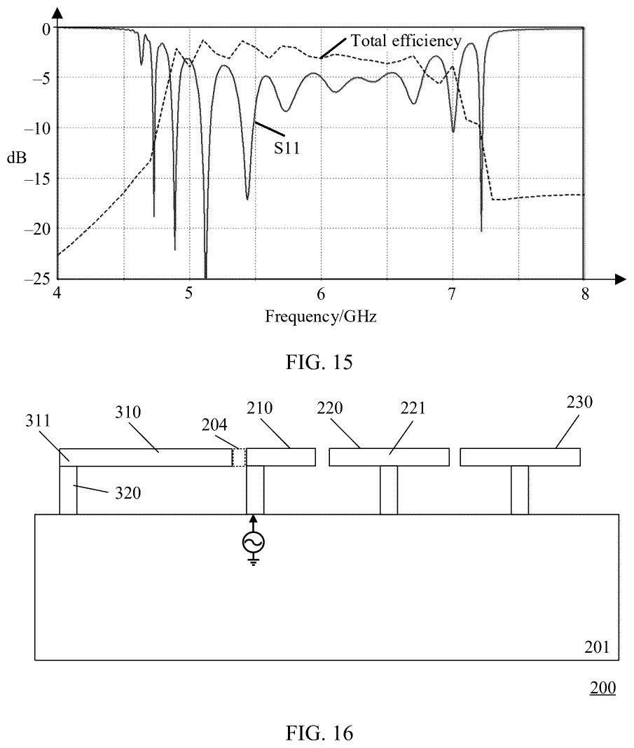

FIG. 15 is a diagram of a simulation result of an S parameter and total efficiency of the antenna structure 200 shown in FIG. 14.

As shown in FIG. 15, when S11<−4 dB, because the clearance of the antenna structure is small, a resonant frequency band of a single resonance is narrow. The antenna structure may generate a plurality of resonances may by using the plurality of T-shaped stubs, and the operating bandwidth of the antenna structure may be increased by using the plurality of resonances. The operating frequency band of the antenna structure may include the 5 GHz frequency band and the 6 GHz frequency band of Wi-Fi.

In addition, total efficiency of the antenna structure in the operating frequency band is greater than −5 dB. That is, the antenna structure has good total efficiency.

FIG. 16 is a diagram of another antenna structure 200 according to an embodiment of this application.

As shown in FIG. 16, the antenna structure 200 may further include a fifth radiator 310 and a fifth grounding member 320.

The third slot 204 is formed between a first end of the fifth radiator 310 and the second end of the first radiator 210. In an embodiment, the first end of the fifth radiator 310 and the second end of the first radiator 210 are opposite and not in contact with each other. The fifth radiator 310 includes a fifth grounding point 311, a first end of the fifth grounding member 320 is connected to the fifth radiator 310 at the fifth grounding point 311, and a second end of the fifth grounding member 320 is grounded through the ground plane 201. In an embodiment, the fifth grounding point 311 is located at the second end of the fifth radiator 310.

It should be understood that a difference between the antenna structure 200 shown in FIG. 16 and the antenna structure 200 shown in FIG. 3 lies only in the fifth radiator 310 and the fifth grounding member 320. In the antenna structure 200 shown in FIG. 16, the fifth radiator 310 and the fifth grounding member 320 may be configured to generate a fourth resonance, so that the operating frequency band of the antenna structure 200 may include a fourth frequency band. The fourth frequency band is different from the first frequency band, the second frequency band, and the third frequency band, and can expand the operating frequency band of the antenna structure 200.

In an embodiment, a resonant frequency band of the fourth resonance may include the 2.4 GHz frequency band (2.4 GHz to 2.483 GHZ) of Wi-Fi, and the operating frequency band of the antenna structure 200 may include all frequency bands of Wi-Fi.

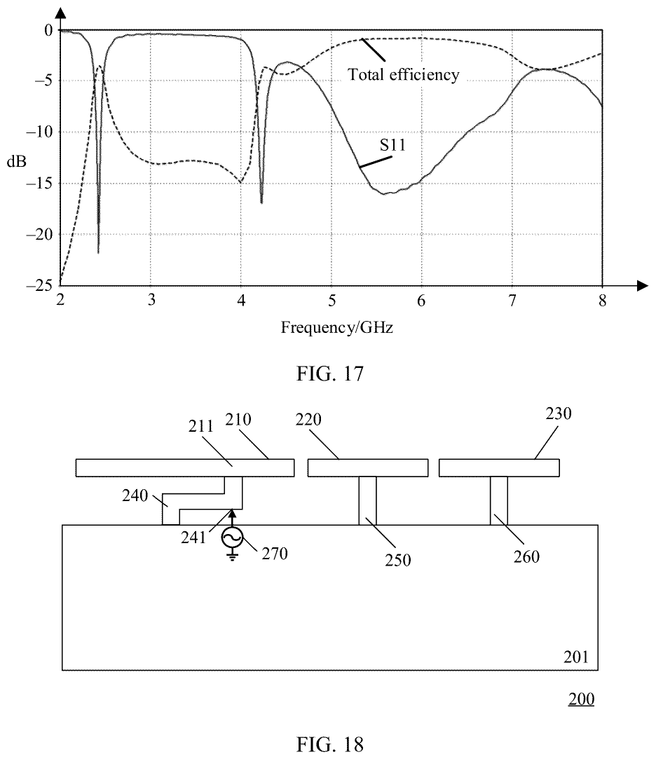

FIG. 17 is a diagram of a simulation result of an S parameter and total efficiency of the antenna structure 200 shown in FIG. 16.

As shown in FIG. 17, the antenna structure may generate resonances near 2.4 GHz and 4.2 GHZ, and the resonances may correspond to the fifth resonance and the third resonance. Because a resonant point of the first resonance and a resonant point of the second resonance are close to each other, the resonant point of the first resonance and the resonant point of the second resonance are synthesized into a resonant frequency band in S11 shown in FIG. 17. When S11<−4 dB, the operating frequency band of the antenna structure may include the 2.4 GHz frequency band, the 5 GHz frequency band, and the 6 GHz frequency band of Wi-Fi.

In addition, total efficiency of the antenna structure in the operating frequency band is greater than −5 dB. That is, the antenna structure has good total efficiency.

FIG. 18 is a diagram of another antenna structure 200 according to an embodiment of this application.

As shown in FIG. 18, the first radiator 210 may have the second end, and the first grounding point 211 may be disposed between the first end and the second end of the first radiator 210.

In an embodiment, a distance from the second end of the first radiator 210 to the first grounding point 211 may be different from the distance from the first end of the first radiator 210 to the first grounding point 211. It should be understood that the distances being different may be understood as that a difference between a distance from an end part of the second end of the first radiator 210 to the first grounding point 211 and a distance from an end part of the first end of the first radiator 210 to the first grounding point 211 are greater than 5 mm.

In an embodiment, a distance from the second end of the first radiator 210 to the first grounding point 211 may be basically the same as the distance from the first end of the first radiator 210 to the first grounding point 211. It should be understood that the distances being basically the same may be understood as that a difference between a distance from an end part of the second end of the first radiator 210 to the first grounding point 211 and a distance from an end part of the first end of the first radiator 210 to the first grounding point 211 is within 10%.

It should be understood that a difference between the antenna structure 200 shown in FIG. 18 and the antenna structure 200 shown in FIG. 3 lies in that a part of the radiator is extended to a second side (namely, a side away from the second radiator) of the first grounding point 211. In the antenna structure 200 shown in FIG. 18, a part (namely, the part of radiator that is additionally extended based on the antenna structure 200 shown in FIG. 3) between the second end of the first radiator 210 and the first grounding point 211 may be used to generate a fifth resonance, so that the operating frequency band of the antenna structure 200 may include a fourth frequency band. The fourth frequency band is different from the first frequency band, the second frequency band, and the third frequency band, and can expand the operating frequency band of the antenna structure 200.

In an embodiment, the distance from the end part of the second end of the first radiator 210 to the first grounding point 211 is greater than the distance from the end part of the first end of the first radiator 210 to the first grounding point 211.

In an embodiment, more radiators may be further disposed on a side that is of the second end of the first radiator 210 and that is away from the first end of the first radiator 210. In an embodiment, the antenna structure 200 may further include one or more T-shaped stubs, which are sequentially disposed on a side close to the second end of the first radiator 210. Each T-shaped stub is provided with a corresponding grounding point and is coupled to a corresponding grounding member. A length of each T-shaped stub and a length of each corresponding grounding member are both applicable to the descriptions in the foregoing embodiments. It should be understood that, starting from the embodiment in FIG. 18, it is equivalent to that the one or more T-shaped stubs may be disposed on the left of the first radiator 210. The T-shaped stub on the left of the first radiator 210 corresponds to a resonant mode in which the second end of the first radiator 210, the first grounding point 211, and the first grounding member 240 are used as an active radiator. A T-shaped stub on the right of the first radiator 210 corresponds to a resonant mode in which the first end of the first radiator 210, the first grounding point 211, and the first grounding member 240 are used as an active radiator.

In an embodiment, a resonant frequency band of the fifth resonance may include the 2.4 GHz frequency band (2.4 GHz to 2.483 GHZ) of Wi-Fi, and the operating frequency band of the antenna structure 200 may include all frequency bands of Wi-Fi.

In an embodiment, the first grounding member 240 may be in a fold-line shape, so that a distance from the first radiator 210 to the ground plane 201 (namely, a clearance) is small, and the first grounding member 240 has a longer electrical length. In an embodiment, the second grounding member 250 or the third grounding member 260 may be in a fold-line shape.

In an embodiment, the lengths of the first grounding member 240, the second grounding member 250, and the third grounding member 260 may be different.

In an embodiment, the feed point 241 may be disposed between the first end and the second end of the first grounding member 240.

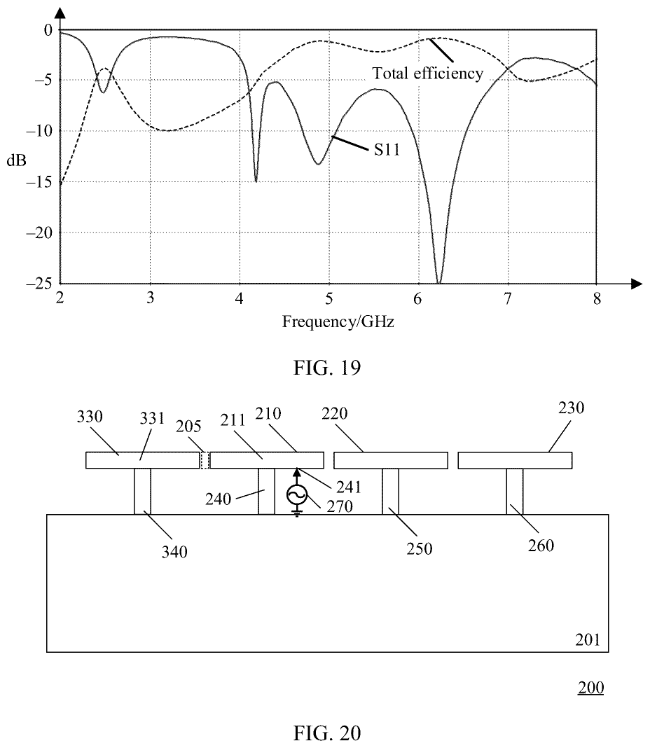

FIG. 19 is a diagram of a simulation result of an S parameter and total efficiency of the antenna structure 200 shown in FIG. 18.

As shown in FIG. 19, the antenna structure may generate resonances near 2.4 GHz, 4.2 GHz, 4.8 GHz, and 6.2 GHZ, and the resonances correspond to the fifth resonance, the third resonance, the first resonance, and the second resonance. When S11<−4 dB, the operating frequency band of the antenna structure may include the 2.4 GHz frequency band, the 5 GHz frequency band, and the 6 GHz frequency band of Wi-Fi.

In addition, total efficiency of the antenna structure in the operating frequency band is greater than −5 dB. That is, the antenna structure has good total efficiency.

FIG. 20 is a diagram of another antenna structure 200 according to an embodiment of this application.

As shown in FIG. 20, the antenna structure 200 may further include a sixth radiator 330 and a sixth grounding member 340.

A fifth slot 205 is formed between a first end of the sixth radiator 330 and the second end of the first radiator 210, and a second end of the sixth radiator 330 is an open end. In an embodiment, the first end of the sixth radiator 330 and the second end of the first radiator 210 are opposite and not in contact with each other. The sixth radiator 330 includes a sixth grounding point 331, a first end of the sixth grounding member 340 is connected to the sixth radiator 330 at the sixth grounding point 331, and a second end of the sixth grounding member 340 is grounded through the ground plane 201.

A sum L6 of the distance from the second end of the first radiator 210 to the first grounding point 211 and the length of the first grounding member 240, a sum L7 of a distance from the first end of the sixth radiator 330 to the sixth grounding point 331 and a length of the sixth grounding member 340, and a sum L8 of a distance from the second end of the sixth radiator 330 to the sixth grounding point 331 and the length of the sixth grounding member 340 satisfy L6, L7, and L8≤3λ/10, where A is the wavelength corresponding to the first frequency band.

In an embodiment, L6, L7, and L8 satisfy L6, L7, and L8≥λ/10.

In an embodiment, L6, L7, and L8 satisfy L1×90%≤L6, L7, and/or L8≤L1×110%.

In an embodiment, the feed point 241 is located on the first radiator 210. The feed unit 270 is coupled to the first radiator 210 at the feed point 241, and feeds an electrical signal for the antenna structure 200.

It should be understood that a difference between the antenna structure 200 shown in FIG. 20 and the antenna structure 200 shown in FIG. 18 lies only in that distances from the two ends of the first radiator to the first grounding point 211 are approximately the same, and a T-shaped structure formed by the sixth radiator 330 and the sixth grounding member 340 is added based on the antenna structure 200 shown in FIG. 18. In the antenna structure 200 shown in FIG. 20, a part between the second end of the first radiator 210 and the first grounding point 211 and the T-shaped structure formed by the sixth radiator 330 and the sixth grounding member 340 may be used, so that the antenna structure can generate a new resonance, and a resonant frequency band of the newly generated resonance is used to increase the operating bandwidth of the antenna structure.

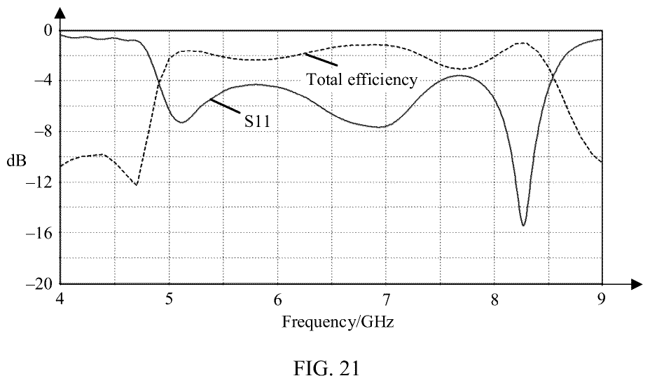

FIG. 21 is a diagram of a simulation result of an S parameter and total efficiency of the antenna structure 200 shown in FIG. 20.

As shown in FIG. 21, when S11<−4 dB, the operating frequency band of the antenna structure may include 4.9 GHZ to 8.5 GHZ, and the antenna structure has a wide operating bandwidth.

In addition, total efficiency of the antenna structure in the operating frequency band is greater than −4 dB. That is, the antenna structure has good total efficiency.

A person skilled in the art may clearly understand that, for the purpose of convenient and brief description, for a specific working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings, direct couplings, or communication connections may be implemented through some interfaces. The indirect couplings or communication connections between the apparatuses or units may be implemented in electrical, mechanical, or another form.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-20. (canceled)

21. An antenna structure, comprising:
a first radiator having a first grounding point;
a second radiator coupled to the first radiator via a first slot formed between a first end of the first radiator and a first end of the second radiator, the second radiator having a second grounding point;
a third radiator-coupled to the second radiator via a second slot formed between a second end of the second radiator and a first end of the third radiator, wherein a second end of the third radiator is an open end, and the third radiator comprises a third grounding point;
a ground plane disposed with a gap between the ground plane and each of the first radiator, the second radiator, and the third radiator;
a first grounding member, wherein a first end of the first grounding member is coupled to the first radiator at the first grounding point, and a second end of the first grounding member is coupled to the ground plane;
a second grounding member, wherein a first end of the second grounding member is coupled to the second radiator at the second grounding point, and a second end of the second grounding member is coupled to the ground plane;
a third grounding member, wherein a first end of the third grounding member is coupled to the third radiator at the third grounding point, and a second end of the third grounding member is coupled to the ground plane; and
a feed unit coupled to the first radiator or the first grounding member at a feed point of the first radiator or the first grounding member.

22. The antenna structure according to claim 21, wherein
a distance d1 from the first end of the first radiator to the first grounding point, a distance d2 from the first end of the second radiator to the second grounding point, a distance d3 from the second end of the second radiator to the second grounding point, a distance d4 from the first end of the third radiator to the third grounding point, and a distance d5 from the second end of the third radiator to the third grounding point, satisfy d1×90%≤d2, d3, d4, and/or d5≤d1×110%.

23. The antenna structure according to claim 21, wherein
an operating frequency band of the antenna structure comprises a first frequency band; and
a sum L1 of the distance d1 from the first end of the first radiator to the first grounding point and a length of the first grounding member, a sum L2 of the distance d2 from the first end of the second radiator to the second grounding point and a length of the second grounding member, a sum L3 of the distance d3_from the second end of the second radiator to the second grounding point and the length of the second grounding member, a sum L4 of the distance d4 from the first end of the third radiator to the third grounding point and a length of the third grounding member, and a sum L5 of the distance d5 from the second end of the third radiator to the third grounding point and the length of the third grounding member are all less than or equal to
$$\frac{3}{10} λ ,$$
wherein λ is a wavelength corresponding to the first frequency band.

24. The antenna structure according to claim 21, wherein L1, L2, L3, L4, and L5 are all greater than or equal to
$$\frac{1}{10} λ .$$

25. The antenna structure according to claim 21, wherein L1, L2, L3, L4, and L5 satisfy: at least one of L1×90%≤L2, L3, L4, or L5≤L1×110%.

26. The antenna structure according to claim 21, wherein the first radiator, the second radiator, and the third radiator are configured to jointly generate a first resonance, a second resonance, and a third resonance, a frequency of the first resonance is lower than a frequency of the second resonance, and the frequency of the second resonance is lower than a frequency of the third resonance.

27. The antenna structure according to claim 264, wherein
at a first resonant frequency covered by the first resonance, currents on the first radiator and the second radiator on two sides of the first slot are in a same direction, currents on the second radiator on two sides of the second grounding point are in reverse directions, currents on the second radiator and the third radiator on two sides of the second slot are in a same direction, and currents on the third radiator on two sides of the third grounding point are in reverse directions;
at a second resonant frequency covered by the second resonance, the currents on the first radiator and the second radiator on the two sides of the first slot are in a same direction, the currents on the second radiator on the two sides of the second grounding point are in a same direction, the currents on the second radiator and the third radiator on the two sides of the second slot are in a same direction, and the currents on the third radiator on the two sides of the third grounding point are in reverse directions; and
at a third resonant frequency covered by the third resonance, the currents on the first radiator and the second radiator on the two sides of the first slot are in a same direction, the currents on the second radiator on the two sides of the second grounding point are in a same direction, the currents on the second radiator and the third radiator on the two sides of the second slot are in a same direction, and the currents on the third radiator on the two sides of the third grounding point are in a same direction.

28. The antenna structure according to claim 21, further comprising:
a fourth radiator having a fourth grounding point
wherein the first grounding point is disposed between the first end of the first radiator and a second end of the first radiator, wherein
a third slot is formed between a first end of the fourth radiator and the second end of the first radiator;
a second end of the fourth radiator is an open end; and
a fourth grounding member, wherein a first end of the fourth grounding member is coupled to the fourth radiator at the fourth grounding point, and a second end of the fourth grounding member is coupled to the ground plane.

29. The antenna structure according to claim 21, wherein the first radiator further comprises a second end, the first grounding point is disposed between the first end of the first radiator and the second end of the first radiator, and a distance from the second end of the first radiator to the first grounding point is different from a distance from the first end of the first radiator to the first grounding point.

30. The antenna structure according to claim 21, wherein
the first grounding member comprises a first part and a second part that are connected, the first part is coupled to the first radiator at the first grounding point, and the second part is coupled to the ground plane; and
a first plane on which the first part is located is different from a second plane on which the second part is located.

31. The antenna structure according to claim 21, wherein
a width of the first slot is less than or equal to 1 mm, and/or a width of the second slot is less than or equal to 1 mm.

32. The antenna structure according to claim 21, wherein
a projection of the first radiator on the ground plane and a projection of the second radiator on the ground plane partially overlap.

33. The antenna structure according to claim 21, wherein
a projection of the first radiator on the ground plane and a projection of the second radiator on the ground plane do not overlap.

34. The antenna structure according to claim 33, wherein at least one of the first slot or the second slot is in a fold-line shape.

35. An electronic device, comprising:
an antenna structure, comprising:
a first radiator having a first grounding point;
a second radiator coupled to the first radiator via a first slot formed between a first end of the first radiator and a first end of the second radiator, the second radiator having a second grounding point;
a third radiator coupled to the second radiator via a second slot formed between a second end of the second radiator and a first end of the third radiator, wherein a second end of the third radiator is an open end, and the third radiator comprises a third grounding point;
a ground plane disposed with a gap between the ground plane and each of the first radiator, the second radiator, and the third radiator;
a first grounding member, wherein a first end of the first grounding member is coupled to the first radiator at the first grounding point, and a second end of the first grounding member is coupled to the ground plane,
a second grounding member, wherein a first end of the second grounding member is coupled to the second radiator at the second grounding point, and a second end of the second grounding member is coupled to the ground plane,
a third grounding member, wherein a first end of the third grounding member is coupled to the third radiator at the third grounding point, and a second end of the third grounding member is coupled to the ground plane; and
a feed unit coupled to the first radiator or the first grounding member at a feed point of the first radiator or the first grounding member.

36. The electronic device according to claim 35, wherein
the electronic device further comprises a support plate;
a first radiator and a third radiator are disposed on a first surface of the support plate, and a second radiator is disposed on a second surface of the support plate; and
a projection of the first radiator on the second surface and the second radiator partially overlap, and a projection of the third radiator on the second surface and the second radiator partially overlap.

37. The electronic device according to claim 36, wherein
the support plate comprises a part of a printed circuit board, or the support plate comprises an insulation support.

38. The electronic device according to claim 35, wherein
the electronic device further comprises an insulation housing; and
the first radiator, the second radiator, and the third radiator are all disposed on the housing.

39. The electronic device according to claim 35, wherein
a distance d1 from the first end of the first radiator to the first grounding point, a distance d2 from the first end of the second radiator to the second grounding point, a distance d3 from the second end of the second radiator to the second grounding point, a distance d4 from the first end of the third radiator to the third grounding point, and a distance d5 from the second end of the third radiator to the third grounding point, satisfy at least one of d1×90%≤d2, d3, d4, or d5≤d1×110%.

40. The electronic device according to claim 35, wherein the first radiator, the second radiator, and the third radiator are configured to jointly generate a first resonance, a second resonance, and a third resonance, a frequency of the first resonance is lower than a frequency of the second resonance, and the frequency of the second resonance is lower than a frequency of the third resonance.
